(19) United States
(12) Patent Application Publication
(10) Pub. No.: US 2025/0351176 A1
(43) Pub. Date: Nov. 13, 2025

(54) SIGNALING OF IN-DEVICE COEXISTENCE INFORMATION VIA MULTI-STATION BLOCK ACKNOWLEDGE FRAME IN WIRELESS LOCAL AREA NETWORK SYSTEM

(71) Applicant: LG ELECTRONICS INC., Seoul (KR)

(72) Inventors: Insun JANG, Seoul (KR); Jinsoo CHOI, Seoul (KR); Hongwon LEE, Seoul (KR); Sunhee BAEK, Seoul (KR); Geonhwan KIM, Seoul (KR); Yelin YOON, Seoul (KR); Dongju CHA, Seoul (KR)

(73) Assignee: LG ELECTRONICS INC., Seoul (KR)

(21) Appl. No.: 19/195,104

(22) Filed: Apr. 30, 2025

(30) Foreign Application Priority Data
May 7, 2024 (KR) 10-2024-0060138
May 8, 2024 (KR) 10-2024-0060851

(51) Int. Cl. H04W 74/0816; H04L 1/1607; H04L 5/00; H04W 56/00

(52) U.S. Cl. CPC H04W 74/0816; H04L 1/1614; H04L 5/0053; H04W 56/0015

(57) ABSTRACT

The present disclosure is related to signaling of in-device coexistence (IDC) information via multi-station (STA) block acknowledgement (BA) frame in a wireless local area network (WLAN) system. According to an embodiment of the present disclosure, a method performed by a STA configured to operate in a WLAN system comprises: receiving a frame; and transmitting a multi-STA block acknowledgement (BA) frame comprising unavailability information related to the STA in response to the frame, wherein BA information field of the multi-STA BA frame comprises per association identifier (AID) traffic identifier (TID) information subfield related to the STA, and wherein the unavailability information is included in the per AID TID information subfield based on an AID TID information subfield of the per AID TID information subfield being set to a specific value.

### CROSS-REFERENCE TO RELATED APPLICATIONS

Pursuant to 35 U.S.C. § 119 (a), this application claims the benefit of earlier filing date and right of priority to Korean Patent Application Nos. 10-2024-0060138, filed on May 7, 2024, and 10-2024-0060851, filed on May 8, 2024, the contents of which are all hereby incorporated by reference herein in their entireties.

### TECHNICAL FIELD

The present disclosure is related to signaling of in-device coexistence (IDC) information via multi-station (STA) block acknowledgement (BA) frame in a wireless local area network (WLAN) system.

### BACKGROUND

Next-generation Wi-Fi (e.g., IEEE 802.11be and/or later) aims to support ultra-high reliability in signaling to STAs, and various technologies are being considered to support high throughput, low latency, and extended range. For example, IDC may occur in AP/STA, and AP/STA may signal information informing that IDC will occur.

### SUMMARY

An aspect of the present disclosure is to provide method and apparatus for signaling of IDC information via multi-STA BA frame in a WLAN system.

According to an embodiment of the present disclosure, a method performed by a STA configured to operate in a WLAN system comprises: receiving a frame; and transmitting a multi-STA block acknowledgement (BA) frame comprising unavailability information related to the STA in response to the frame, wherein BA information field of the multi-STA BA frame comprises per association identifier (AID) traffic identifier (TID) information subfield related to the STA, and wherein the unavailability information is included in the per AID TID information subfield based on an AID TID information subfield of the per AID TID information subfield being set to a specific value.

According to an embodiment of the present disclosure, a method performed by an AP configured to operate in a WLAN system comprises: transmitting a frame to a station (STA); and receiving a multi-STA block acknowledgement (BA) frame comprising unavailability information related to the STA in response to the frame, wherein BA information field of the multi-STA BA frame comprises per association identifier (AID) traffic identifier (TID) information subfield related to the STA, and wherein the unavailability information is included in the per AID TID information subfield based on an AID TID information subfield of the per AID TID information subfield being set to a specific value.

In various embodiments, apparatuses implementing the above methods are provided.

The present disclosure may have various advantageous effects.

For example, an AP/STA that has received IDC information from a counterpart STA may not transmit frames to the counterpart STA during IDC duration so that Wi-Fi performance degradation can be prevented.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a transmitting apparatus and/or receiving apparatus of the present disclosure.

FIG. 2 is a conceptual view illustrating the structure of a wireless local area network (WLAN).

FIG. 3 illustrates a general link setup process.

FIG. 4 shows an example of a multi-link (ML).

FIG. 5 shows a modified example of a transmitting device and/or a receiving device of the present disclosure.

FIG. 6 shows an example of a physical protocol data unit or physical layer (PHY) protocol data unit (PPDU) transmitted/received by an STA of the present disclosure.

FIG. 7 shows an operation related to UL-MU.

FIG. 8 shows an example of a header of a MAC frame.

FIG. 9 shows an example of a frame format of the BlockAckReq frame.

FIG. 10 shows a format of the BAR control field.

FIG. 11 shows a format of the Block Ack Starting Sequence Control subfield.

FIG. 12 shows a format of the BAR Information field of the Multi-TID BlockAckReq frame.

FIG. 13 shows a format of the Per TID Info subfield.

FIG. 14 shows a format of BlockAck frame.

FIG. 15 shows a format of the BA control field.

FIG. 16 shows a format of the BA Information field of the Compressed BlockAck frame.

FIG. 17 shows a format of the BA Information field of the Multi-STA BlockAck frame.

FIG. 18 shows a format of the AID TID Info subfield.

FIG. 19 shows a format of the Per AID TID Info subfield if the AID11 subfield is not 2045.

FIG. 20 shows a format of the Per AID TID Info subfield if the AID11 subfield is 2045.

FIG. 21 shows an example of a situation in which an IDC occurs.

FIG. 22 shows an example of a method performed by a STA for signaling of IDC information via a multi-STA BA frame according to an embodiment of the present disclosure.

FIG. 23 shows an example of a method performed by an AP for signaling of IDC information via multi-STA BA frame according to an embodiment of the present disclosure.

FIG. 24 shows an example of an IDC information field including a Presence bitmap according to an embodiment of the present disclosure.

FIG. 25 shows an example of an IDC information field including fields about fully unavailability and periodicity according to an embodiment of the present disclosure.

FIG. 26 shows an example of an IDC information field including a length field according to an embodiment of the present disclosure.

FIG. 27 shows an example of a generalized control information field including a field for the number of control information fields according to an embodiment of the present disclosure.

FIG. 28 shows a first example of a structure of a Multi-STA BA frame including IDC information according to an embodiment of the present disclosure.

FIG. 29 shows a second example of a structure of a Multi-STA BA frame including IDC information according to an embodiment of the present disclosure.

FIG. 30 shows an example of a format of a Per AID TID Info subfield including IDC/unavailability information according to an embodiment of the present disclosure.

FIG. 31 shows an example of a format of the Block Ack Starting Sequence Control subfield when IDC/unavailability information is included according to an embodiment of the present disclosure.

FIG. 32 shows an example of a format of a feedback subfield according to an embodiment of the present disclosure.

FIG. 33 shows a third example of a structure of a Multi-STA BA frame including IDC information according to an embodiment of the present disclosure.

FIG. 34 shows an example of transmitting a Multi-STA BA frame including IDC information as a response to a frame according to an embodiment of the present disclosure.

### DETAILED DESCRIPTION

In the present disclosure, “A or B” may mean “only A”, “only B” or “both A and B”. In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, a parenthesis used in the present disclosure may mean “for example”. Specifically, when indicated as “control information (UHR-signal field)”, it may mean that “UHR-signal field” is proposed as an example of the “control information”. In other words, the “control information” of the present disclosure is not limited to “UHR-signal field”, and “UHR-signal field” may be proposed as an example of the “control information”. In addition, when indicated as “control information (i.e., UHR-signal field)”, it may also mean that “UHR-signal field” is proposed as an example of the “control information”.

Also, “a/an” as used in this disclosure can mean “at least one” or “one or more.” Also, a term ending with “(s)” can mean “at least one” or “one or more.”

Also, the expressions “based on” or “on the basis of” or “according to” as used in this disclosure mean “based at least in part on,” and do not mean “based sonly on.”

Technical features described individually in one figure in the present disclosure may be individually implemented, or may be simultaneously implemented.

The following example of the present disclosure may be applied to various wireless communication systems. For example, the following example of the present disclosure may be applied to a wireless local area network (WLAN) system. For example, the present disclosure may be applied to the IEEE 802.11a/g/n/ac/ax/be/bn standard. In addition, an example of the present disclosure can also be applied to a next-generation wireless LAN standard that enhances the Ultra High Reliability (UHR) standard or IEEE 802.11bn. In addition, the example of the present disclosure may also be applied to a new WLAN standard enhanced from the EHT standard or the IEEE 802.11be standard. In addition, the example of the present disclosure may be applied to a mobile communication system. For example, it may be applied to a mobile communication system based on long term evolution (LTE) depending on a 3rd generation partnership project (3GPP) standard and based on evolution of the LTE. In addition, the example of the present disclosure may be applied to a communication system of a 5G NR standard based on the 3GPP standard.

Hereinafter, in order to describe a technical feature of the present disclosure, a technical feature applicable to the present disclosure will be described.

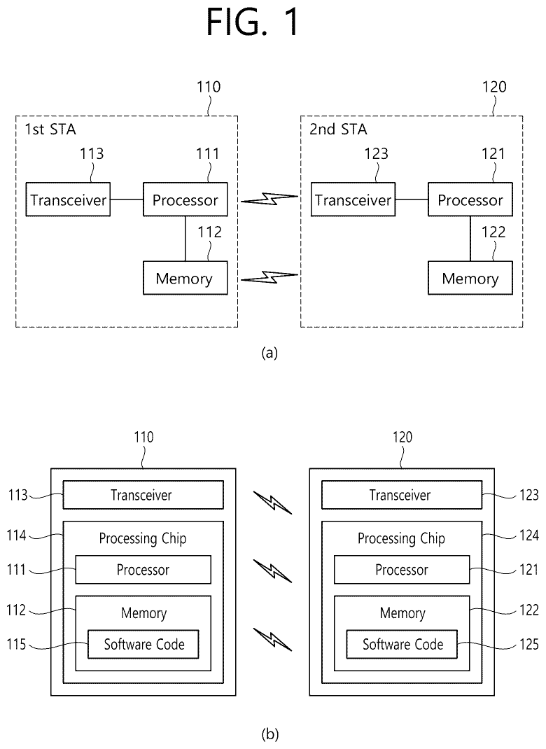

FIG. 1 shows an example of a transmitting apparatus and/or receiving apparatus of the present disclosure.

In the example of FIG. 1, various technical features described below may be performed. FIG. 1 relates to at least one station (STA). For example, STAs 110 and 120 of the present disclosure may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present disclosure may also be called in various terms such as a network, a base station, a node-B, an access point (AP), a repeater, a router, a relay, or the like. The STAs 110 and 120 of the present disclosure may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present disclosure may serve as the AP and/or the non-AP. In the present disclosure, the AP may be indicated as an AP STA.

The STAs 110 and 120 of the present disclosure may support various communication standards together in addition to the IEEE 802.11 standard. For example, a communication standard (e.g., LTE, LTE-A, 5G NR standard) or the like based on the 3GPP standard may be supported. In addition, the STA of the present disclosure may be implemented as various devices such as a mobile phone, a vehicle, a personal computer, or the like. In addition, the STA of the present disclosure may support communication for various communication services such as voice calls, video calls, data communication, and self-driving (autonomous-driving), or the like.

The STAs 110 and 120 of the present disclosure may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the disclosure described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the disclosure described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the disclosure described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present disclosure will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present disclosure may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by Media Tek®, ATOM™ series of processors made by Intel® or processors enhanced from these processors.

In the present disclosure, an uplink may imply a link for communication from a non-AP STA to an AP STA, and an uplink PPDU/packet/signal or the like may be transmitted through the uplink. In addition, in the present disclosure, a downlink may imply a link for communication from the AP STA to the non-AP STA, and a downlink PPDU/packet/signal or the like may be transmitted through the downlink.

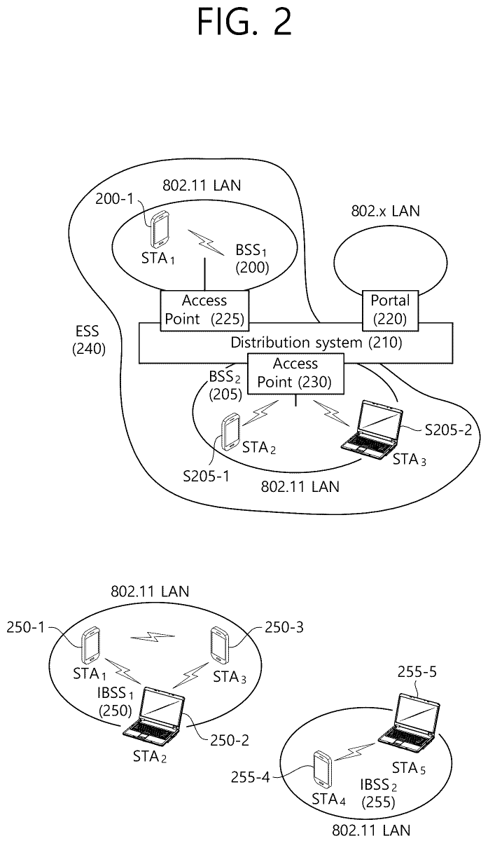

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

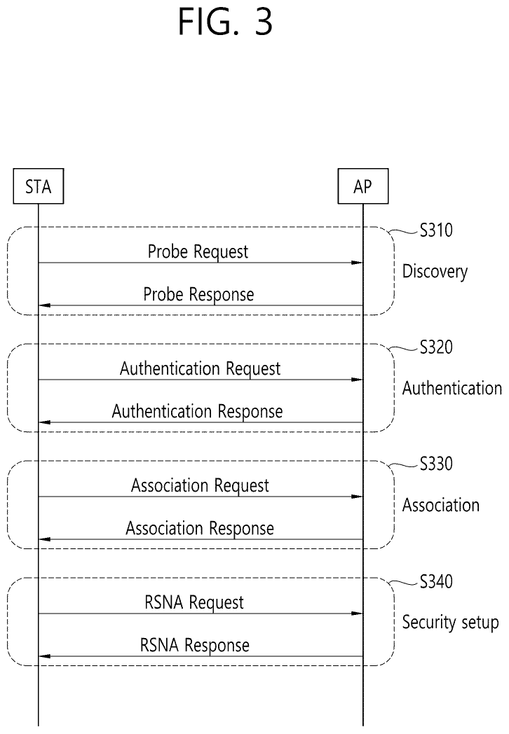

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the ISS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

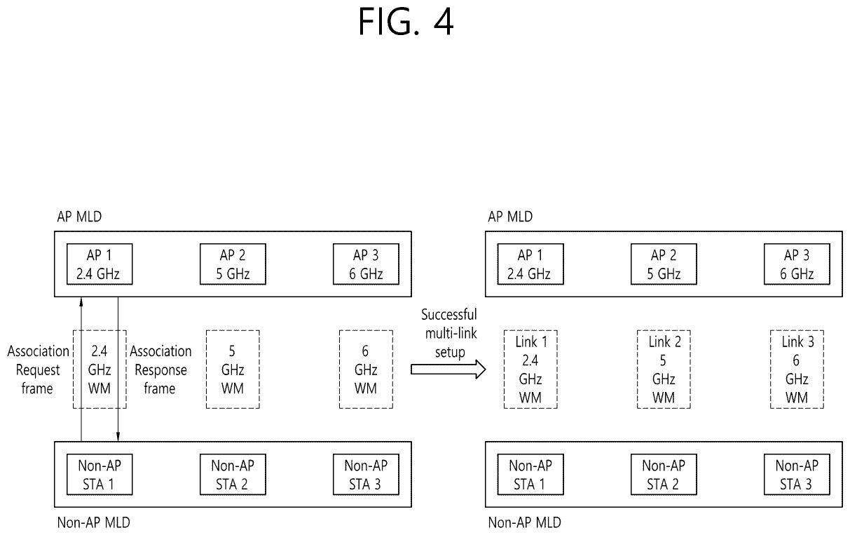

FIG. 4 shows an example of a multi-link (ML).

As illustrated in FIG. 4, multiple multi-link devices (MLDs) can perform communication via a remote link. The MLD can be classified into an AP MLD including multiple AP STAs and a non-AP MLD including multiple non-AP STAs. That is, the AP MLD can include affiliated APs (i.e., AP STAs), and the non-AP MLD can include affiliated STAs (i.e., non-AP STAs, or user-STAs).

The multi-link can include a first link and a second link, and different channels/subchannels/frequency resources can be allocated to the first and second links. The first and second multi-links can be identified through a link ID of 4 bits (or other n bits). The first and second links may be configured in the same 2.4 GHz, 5 GHZ, or 6 GHz band. Alternatively, the first link and the second link may be configured in different bands.

The AP MLD of FIG. 4 includes three affiliated APs. In the example of FIG. 4, AP1 may operate in the 2.4 GHz band, AP2 may operate in the 5 GHz band, and AP3 may operate in the 6 GHz band. In the example of FIG. 4, the first link in which AP1 and non-AP1 operate may be defined as a channel/subchannel/frequency resource within the 2.4 GHz band. In addition, in the example of FIG. 4, the second link in which AP2 and non-AP2 operate may be defined as a channel/subchannel/frequency resource within the 5 GHz band. In addition, in the example of FIG. 4, the third link where AP3 and non-AP3 operate can be defined as a channel/subchannel/frequency resource within the 6 GHz band.

In the example of FIG. 4, AP1 can start a multi-link setup procedure (ML setup procedure) by transmitting an association request frame to non-AP STA1. In the example of FIG. 4, non-AP STA1 can transmit an association response frame in response to the association request frame. Each AP (e.g., AP1/2/3) illustrated in FIG. 4 may be identical to the AP illustrated in FIG. 1 and/or FIG. 2, and each non-AP (e.g., non-AP1/2/3) illustrated in FIG. 4 may be identical to the STA (i.e., user-STA or non-AP STA) illustrated in FIG. 1 and/or FIG. 2.

The specific features of the present disclosure are not limited to the specific features of FIG. 4. That is, the number of links can be defined in various ways, and multiple links can be defined in various ways within at least one band.

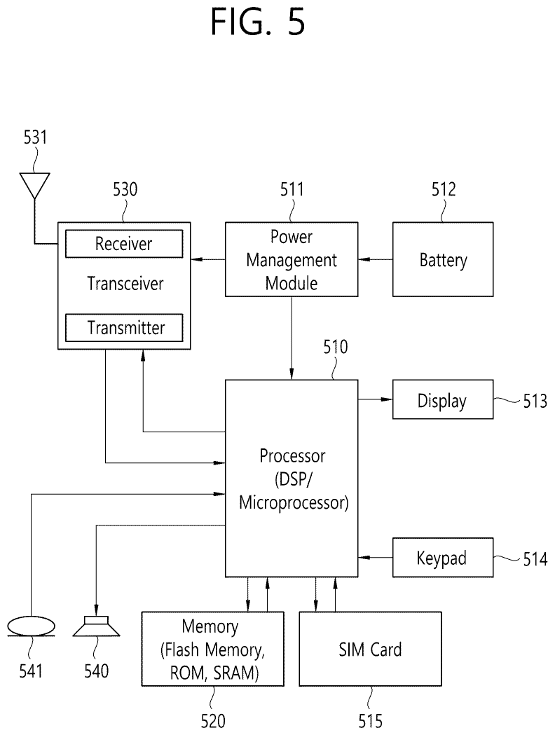

FIG. 5 shows a modified example of a transmitting device and/or a receiving device of the present disclosure.

The devices (e.g., AP STA, non-AP STA) shown in FIGS. 1 to 4 can be modified as shown in FIG. 5. The transceiver 530 of FIG. 5 can be identical to the transceiver 113, 123 of FIG. 1. The transceiver 530 of FIG. 5 can include a receiver and a transmitter.

The processor 510 of FIG. 5 can be identical to the processor 111, 121 of FIG. 1. Alternatively, the processor 510 of FIG. 5 can be identical to the processing chip 114, 124 of FIG. 1.

The memory 150 of FIG. 5 may be the same as the memory 112, 122 of FIG. 1.

Alternatively, the memory 150 of FIG. 5 may be a separate external memory different from the memory 112, 122 of FIG. 1.

Referring to FIG. 5, the power management module 511 manages power for the processor 510 and/or the transceiver 530. The battery 512 supplies power to the power management module 511. The display 513 outputs the result processed by the processor 510. The keypad 514 receives input to be used by the processor 510. The keypad 514 may be displayed on the display 513. The SIM card 515 may be an integrated circuit used to securely store an international mobile subscriber identity (IMSI) and its associated keys, which are used to identify and authenticate subscribers in mobile devices such as mobile phones and computers.

Referring to FIG. 5, the speaker (540) may output sound-related results processed by the processor 510. The microphone (541) may receive sound-related input to be used by the processor 510.

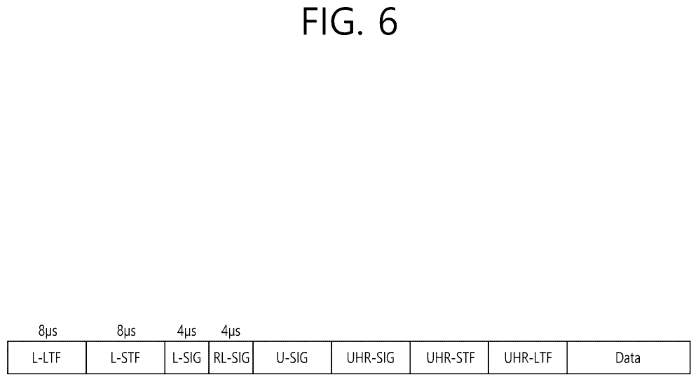

FIG. 6 shows an example of a physical protocol data unit or physical layer (PHY) protocol data unit (PPDU) transmitted/received by an STA of the present disclosure.

An STA (e.g., an AP STA, a non-AP STA, an AP MLD, a non-AP MLD) of the present disclosure can transmit and/or receive a PPDU of FIG. 6. The PPDU described in the present disclosure can have, for example, a structure of FIG. 6. In addition, the PPDU described in the present disclosure can be called by various names such as a transmission PPDU, a reception PPDU, a first type or an N^{th} type PPDU, etc. The PPDU described in the present disclosure can be used in a WLAN system defined according to IEEE 802.11bn and/or a next-generation WLAN system that improves IEEE 802.11bn.

The PPDU of FIG. 6 can be related to various PPDU types used in a UHR system. For example, the example of FIG. 6 can be used for at least one of single-user (SU) mode/type/transmission, multi-user (MU) mode/type/transmission, and null-data packet (NDP) mode/type/transmission related to channel sounding. For example, if the example of FIG. 6 is related to NDP, the data field illustrated can be omitted. If the PPDU of FIG. 6 is used for trigger-based (TB) mode, UHR-SIG of FIG. 6 can be omitted. In other words, an STA that has received a trigger frame for uplink-MU (UL-MU) communication can transmit a PPDU with UHR-SIG omitted in the example of FIG. 6.

In FIG. 6, L-STF or UHR-LTF may be called a preamble or a physical preamble, and may be generated/transmitted/received/acquired/decoded in the physical layer (included in the transmitting/receiving STA).

Each block illustrated in FIG. 6 may be called a field/subfield/signal, etc. The names of these fields/subfields/signals may be legacy short training field (L-STF), legacy long training field (L-LTF), legacy signal (L-SIG), repeated L-SIG (RL-SIG), universal signal (U-SIG), UHR-signal (UHR-SIG), etc., as illustrated in FIG. 6.

A subcarrier spacing of the L-STF, L-LTF, L-SIG, RL-SIG, U-SIG, and UHR-SIG fields of FIG. 6 may be determined as 312.5 kHz, and a subcarrier spacing of the UHR-STF, UHR-LTF, and Data fields may be determined as 78.125 kHz. That is, a tone index (or subcarrier index) of the L-STF, L-LTF, L-SIG, RL-SIG, U-SIG, and UHR-SIG fields may be expressed in unit of 312.5 kHz, and a tone index (or subcarrier index) of the UHR-STF, UHR-LTF, and Data fields may be expressed in unit of 78.125 kHz.

In the PPDU of FIG. 6, the L-LTF and the L-STF may be the same as those in the conventional fields (for example, non-HT LTF and non-HT STF defined in conventional WLAN standards).

The L-SIG field of FIG. 6 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-high throughput (HT), high throughput (HT), very high throughput (VHT) PPDU, extremely high throughput (EHT) PPDU or UHR PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI, EHT PPDU or the UHR PPDU, the value of the length field may be determined as a multiple of 3, and for the high efficiency (HE) PPDU, the value of the length field may be determined as “a multiple of 3”+1 or “a multiple of 3”+2. In other words, the LENGTH field in an UHR PPDU is set to a value satisfying the condition that the remainder is zero when LENGTH is divided by 3

For example, the (non-AP and AP) STA may apply BCC encoding based on a ½ coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier {subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index {−28, −27, +27, +28}. The aforementioned signal may be used for channel estimation in the frequency domain corresponding to {−28, −27, +27, +28}.

For example, the (non-AP and AP) STA may generate an RL-SIG generated in the same manner as the L-SIG. BPSK modulation may be applied to the RL-SIG. The (non-AP and AP) STA may know that the RX PPDU is the HE PPDU, EHT PPDU, or the UHR PPDU, based on the presence of the RL-SIG. In other words, a receiving (non-AP and AP) STA can know that a received PPDU is one of a HE PPDU, an EHT PPDU, and a UHR PPDU if RL-SIG is present. In other words, a receiving (non-AP and AP) STA can know that a received PPDU is one of a non-HT PPDU, an HT PPDU, and a VHT PPDU if RL-SIG is not present. In other words, the RL-SIG field is a repeat of the L-SIG field and is used to differentiate a UHR PPDU from a non-HT PPDU, HT PPDU, and VHT PPDU.

A universal SIG (U-SIG) may be inserted after the RL-SIG of FIG. 6. The U-SIG may be called in various terms such as a first SIG field, a first SIG, a first type SIG, a control signal, a control signal field, a first (type) control signal, common control field, common control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 us. Each symbol of the U-SIG may be used to transmit the 26-bit information. For example, each symbol of the U-SIG may be transmitted/received based on 52 data tomes and 4 pilot tones.

Through the U-SIG for example, A-bit information (e.g., 52 un-coded bits) may be transmitted. A first symbol of the U-SIG may transmit first X-bit information (e.g., 26 un-coded bits) of the A-bit information, and a second symbol of the U-SIG may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=½ to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, ‘000000’.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits (for example, 000 value) may indicate that the TX/RX PPDU is an EHT PPDU. Also, a second value of the PHY version identifier of 3 bits (for example, 001 value) may indicate that the TX/RX PPDU is a UHR PPDU.

In other words, when the (AP/non-AP) STA transmits an EHT PPDU, the 3-bit PHY version identifier can be set to the first value, and when the (AP/non-AP) STA transmits a UHR PPDU, the 3-bit PHY version identifier can be set to the second value. In other words, the receiving (AP/non-AP) STA can determine that the received PPDU is an EHT PPDU based on the PHY version identifier having the first value, and can determine that the received PPDU is a UHR PPDU based on the PHY version identifier having the second value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a transmission opportunity (TXOP) length and information related to a BSS color ID.

For example, if a UHR PPDU is classified into various types (e.g., type related to SU transmission (performed based on UL or DL), type related to DL transmission, type related to NDP transmission, type related to DL non-MU-MIMO, type related to DL MU-MIMO, type related to multi-AP operation, type related to coordinated beamforming (Co-BF), spatial reuse (SR), type related to coordinated OFDMA (C-OFDMA), type related to coordinated TDMA (Co-TDMA)), information about the type of the UHR PPDU (e.g., 2-bit or 3-bit information) can be included in the version-dependent bits of the U-SIG.

For example, the U-SIG may include: 1) a bandwidth field including information related to a bandwidth; 2) a field including information related to an modulation and coding scheme (MCS) applied to UHR-SIG; 3) an indication field including information regarding whether a dual subcarrier modulation (DCM) scheme is applied to UHR-SIG; 4) a field including information related to the number of symbol used for UHR-SIG; 5) a field including information regarding whether the UHR-SIG is generated across a full band; 6) a field including information related to a type of UHR-LTF/STF; and 7) information related to a field indicating an UHR-LTF length and a CP length.

Preamble puncturing may be applied to the PPDU of FIG. 6. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80 MHaz band within the 160 MHz band (or 80+80 MHz band).

Information related to the preamble puncturing applied to the PPDU may be included in U-SIG and/or UHR-SIG. For example, a first field of the U-SIG may include information related to a contiguous bandwidth, and second field of the U-SIG may include information related to the preamble puncturing applied to the PPDU.

For example, the U-SIG and the UHR-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an UHR-SIG contiguous to the first U-SIG may include information related to a preamble puncturing applied to the second 80 MHz band (i.e., information related to a preamble puncturing pattern), and an UHR-SIG contiguous to the second U-SIG may include information related to a preamble puncturing (i.e., information related to a preamble puncturing pattern) applied to the first 80 MHz band.

Additionally or alternatively, the U-SIG and the UHR-SIG may include the information related to the preamble puncturing, based on the following method. The U-SIG may include information related to a preamble puncturing (i.e., information related to a preamble puncturing pattern) for all bands. That is, the UHR-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The UHR-SIG of FIG. 6 may include control information for the receiving STA. The UHR-SIG may be transmitted through at least one symbol, and one symbol may have a length of 4 us. Information related to the number of symbols used for the UHR-SIG may be included in the U-SIG.

UHR-SIG provides an additional signal to the U-SIG field to enable STA to interpret/decode UHR PPDU. UHR-SIG field may include U-SIG overflow bits that are commonly applied to all users. In addition, UHR-SIG field includes resource allocation information, so that STA can look-up resources used in fields including data field/UHR-STF/UHR-LTF (i.e., UHR modulated fields of a UHR PPDU).

Frequency resources of UHR-LTF, UHR-STF, and data fields illustrated in FIG. 6 may be determined based on RUs (resource units) defined by multiple subcarriers/tones. That is, UHR-LTF, UHR-STF, and data fields of the present disclosure may be transmitted/received through RUs (resource units) defined by multiple subcarriers/tones.

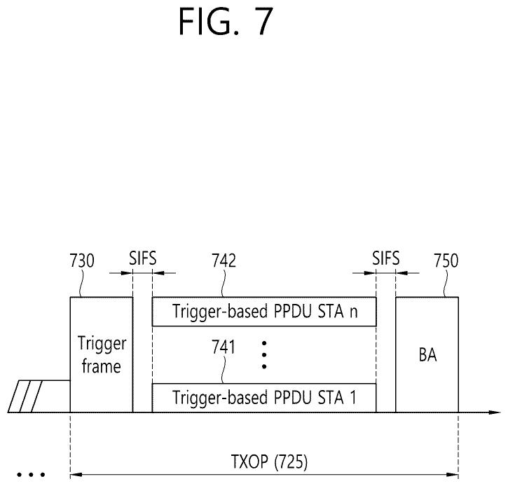

FIG. 7 shows an operation related to UL-MU. As shown, a transmitting STA (e.g., AP) can obtain TXOP 725 by performing channel access through contending (i.e., backoff operation) and transmit trigger frame 730. That is, the transmitting STA (e.g., AP) can transmit PPDU including trigger frame 730. When PPDU including trigger frame is received, trigger-based (TB) PPDU is transmitted after delay of SIFS.

TB PPDU 741, 742 can be transmitted at the same time and transmitted from multiple STA (e.g., user STA) whose AID is indicated in trigger frame 730. ACK frame 750 for TB PPDU can be implemented in various forms. For example, ACK frame 750 for TB PPDU can be implemented in the form of block ACK (BA).

In FIG. 7, transmission(s) of trigger Frame 730, TB PPDU 741, 742 and/or ACK Frame 750 can be performed within TXOP 725.

Hereinafter, the structure and type/subtype of MAC frame are described.

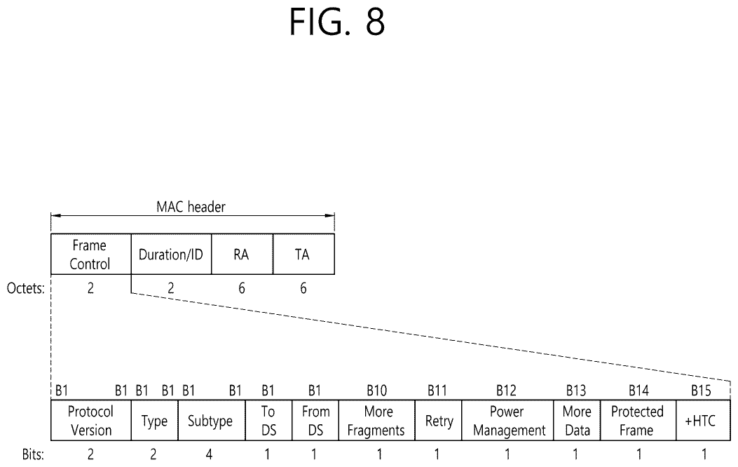

FIG. 8 shows an example of a header of a MAC frame. As shown, the MAC frame can include a frame control field/information of 2 octets in length, a duration field/information of 2 octets in length, an receiver address (RA) field/information of 6 octets in length, and a transmitter address (TA) field/information of 6 octets in length. As shown in FIG. 8, the four fields can be consecutive to each other. The MAC header of FIG. 8 can be modified in various ways, and a new field can be inserted between the four fields shown, or at least one of the fields shown can be omitted.

The MAC header shown in FIG. 8 can be located at the very front of the MAC frame. That is, the MAC frame may include a MAC header as in FIG. 8 and a MAC body field/information that is continuous to the MAC header. The MAC frame including the MAC header of FIG. 8 is inserted/included in the data field of the PPDU (e.g., UHR PPDU) illustrated in FIG. 6.

The MAC frame included in the data field of the PPDU of this disclosure may be classified into various types. For example, the MAC frame of this disclosure may be classified into a control frame, a management frame, and a data frame.

For example, the management frame includes association request, association response, reassociation request, reassociation response, probe request, probe response, beacon, disassociation, authentication, and deauthentication frames/signals defined in the conventional WLAN. For the management frame, the values of the type fields (B3 and B2) of FIG. 8 are set to 00. Also, the values of the subtype fields (B7, B6, B5, B4) of FIG. 8 are as follows: association request (0000), association response (0001), reassociation request (0010), reassociation response (0011), probe request (0100), probe response (0101), beacon (1000), disassociation (1010), authentication (1011), deauthentication (1100).

For example, the control frame includes trigger beamforming report poll, NDP announcement (NDPA), control frame extension, control wrapper, block Ack request (BlockAckReq), Block Ack (BlockAck), PS-Poll, RTS, CTS, Ack, CF-end frames/signals defined in conventional WLAN. For the control frame, the values of the type fields (B3 and B2) of FIG. 8 are set to 01. Also, the values of the subtype fields (B7, B6, B5, B4) of FIG. 8 are as follows: trigger (0010), beamforming report poll (0100), NDP announcement (0101), control frame extension (0110), control wrapper (0111), BlockAckReq (1000), BlockAck (1001), PS-Poll (1010), RTS (1011), CTS (1100), Ack (1101), CF-End (1110).

For example, the data frame includes (QOS) Data, (QOS) Null, etc. defined in the conventional WLAN. For the management frame, the values of the type fields (B3 and B2) of FIG. 8 are set to 10.

The MAC frame/signal used in this disclosure can be identified through the type field/information and subtype field/information described above. For example, a “trigger frame” in this disclosure may mean a MAC frame in which the type bits B3 and B2 bits in the frame control field of the MAC header are set to 01, and the subtype bits B7, B6, B5, and B4 bits in the frame control field are set to 0010. Various MAC frames described in this disclosure are inserted/included in the data fields of various PPDUs (e.g., HE/VHT/HE/EHT/UHR PPDUs).

Hereinafter, block acknowledgement (ACK) (or Block Ack) related features are described.

The block ack mechanism improves channel efficiency by aggregating several acknowledgments into one frame. In the present disclosure, the STA with data to send using the block ack mechanism is referred to as the originator, and the receiver of that data as the recipient.

The block ack mechanism is initialized by an exchange of add block acknowledgement (ADDBA) Request/Response frames except for GLK-GCR block ack or by using the unsolicited block ack extension mechanism. After initialization, blocks of QoS Data frames may be transmitted from the originator to the recipient. A block may be started within a polled TXOP, within an SP, or by winning EDCA contention. The number of frames in the block is limited, and the amount of state that is to be kept by the recipient is bounded. The MPDUs within the block of frames are acknowledged by a block ACK (or, BlockAck/BA) frame, which is requested by a block ACK request (or BlockAckReq/BAR) frame. For GLK-GCR block ACK, the block ACK mechanism is initialized when the GLK STA associates with the GLK AP. The MPDUs within a block of SYNRA addressed Data frames are acknowledged by a BlockAck frame, which is requested by a BlockAckReq frame.

The block ack mechanism does not require the setting up of a TS; however, QOS STAs using the TS facility may choose to signal their intention to use block ack mechanism for the scheduler's consideration in assigning TXOPs. The block ack mechanism is also used by the GCR service. Acknowledgments of frames belonging to the same TID, but transmitted during multiple TXOPs/SPs, may also be combined into a single BlockAck frame. This mechanism allows the originator to have flexibility regarding the transmission of Data frames. The originator may split the block of frames across TXOPs/SPs, separate the data transfer and the block ack exchange, and interleave blocks of MPDUs carrying all or part of MSDUs or A-MSDUs for different TIDs or RAs.

A non-AP SIG STA may negotiate an asymmetric BA with an SIG AP. A non-SIG STA shall not transmit NDP BlockAck frames and shall not initiate an asymmetric BA. An SIG AP with dot11AsymmetricBlockAckActivated equal to false shall not support asymmetric BA. Under asymmetric BA operation, the responding S1G STA may use a lower MCS for transmitting the immediate BlockAck frame. The intended recipient STA maintains a measure of the degree of asymmetry between the AP and the STA and implicitly indicates the value to the originator AP during the block ack setup phase. This degree of asymmetry is represented as the difference in MCS values between AP and STA, and referred to as MCSDifference (see 10.25.2 (Setup and modification of the block ack parameters)). After an asymmetric BA agreement is established, the originator AP uses the CSDifference to calculate the Duration field of PVO frames carried in the A-MPDU that elicits the BlockAck frame.

An SIG STA that sets the STA Type Support subfield in a transmitted SIG Capabilities element to 0 or 2, shall support the HT-immediate block ack extension. An SIG STA that sets the A-MPDU Supported field in the SIG Capabilities element to 1 shall support the HT-immediate block ack extension.

If association is between MLDs, then the block ack agreement is established between two MLDs and follows the rules of Block ack procedures in Multi-link operation. If association is between STAs, then the block ack agreement established is between the two STAs and follows the rules regarding setup and modification of the block ack parameters.

After setting up an immediate block ack agreement, and having gained access to the medium and established protection, if necessary, the originator may transmit an A-MPDU. The RA field of the frames that are not delivered using the GCR block ack retransmission policy shall be the recipient's individual address. The RA field in GCR frames delivered using the GCR block ack retransmission policy shall be set to the GCR concealment address. The RA field in Data frames delivered using the GLK-GCR block ack retransmission policy shall be set to a SYNRA. The originator requests acknowledgment of outstanding QoS Data frames by sending a BlockAckReq frame.

The Multi-TID BlockAck variant shall be used for all BlockAck frames related to an HT-immediate agreement transmitted inside a PSMP sequence and shall not be used otherwise. For non-HE STAs, the Multi-TID BlockAckReq variant shall be used for all BlockAckReq frames related to an HT-immediate agreement transmitted inside a PSMP sequence and shall not be used otherwise. The Multi-TID BlockAckReq variant can be used between HE STAs to solicit a Multi-STA BlockAck frame for Multi-TID A-MPDUs.

In a DMG BSS, if the Compressed BlockAckReq variant is used related to an HT-immediate agreement, then all of the following BlockAck and BlockAckReq frames transmitted as part of the HT-immediate agreement shall use the Compressed BlockAck and Compressed BlockAckReq variants.

In a DMG BSS, if the Extended Compressed BlockAckReq variant is used related to an HT-immediate agreement, then all of the following BlockAck and BlockAckReq frames transmitted as part of the HTimmediate agreement shall use the Extended Compressed BlockAck and Extended Compressed BlockAckReq variants.

GCR BlockAck and GCR BlockAckReq variants shall be used in a GCR block ack agreement. GLKGCR BlockAck and GLK-GCR BlockAckReq variants shall be used in a GLK-GCR block ack agreement.

The SIG recipient of an accepted block ack agreement that was negotiated with NDP ADDBA shall use NDP BlockAck frames instead of BlockAck frames to acknowledge MPDUs within A-MPDUs during an HT-immediate block ack agreement.

The SIG recipient of an accepted block ack agreement that was negotiated with BAT ADDBA shall use BAT frames instead of BlockAck frames to acknowledge MPDUs within A-MPDUs during an HTimmediate block ack agreement. Otherwise, the SIG recipient of an accepted block ack agreement shall not use BAT frames.

The SIG recipient of an accepted block ack agreement that was negotiated with ADDBA shall use BlockAck frames to acknowledge MPDUs within A-MPDUs during an HT-immediate block ack agreement.

The SIG recipient of an accepted block ack agreement that was negotiated with either ADDBA Request/NDP ADDBA Response or NDP ADDBA Request/ADDBA Response shall use either NDP BlockAck or BlockAck frames depending on the type of response frame elicited by the S1G originator. The type of response shall be:
An NDP BlockAck frame if the RXVECTOR parameter RESPONSE_INDICATION of the eliciting PPDU that contains a BlockAckReq or an A-MPDU is equal to NDP Response;
A BlockAck frame if the RXVECTOR parameter RESPONSE_INDICATION of the eliciting PPDU that contains a BlockAckReq or an A-MPDU is equal to Normal Response; and/or
A PPDU that contains a BlockAck frame if the RXVECTOR parameter RESPONSE_INDICATION of the eliciting PPDU is equal to Long Response.

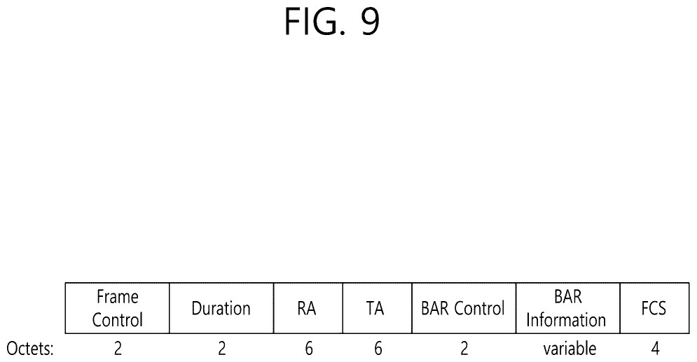

FIG. 9 shows an example of a frame format of the BlockAckReq frame.

Referring to FIG. 9, the BlockAckReq frame comprises frame control field, duration field, RA (receiver address) field, TA (transmitter address) field, BAR control field, BAR information field, and/or FCS (frame check sequence) field.

The duration field value is related to the duration of the NAV timer set by the STA whose MAC address is not identical to the address of the recipient STA.

The RA field of the BlockAckReq frame is the address of the recipient STA.

The TA field value is the address of the STA transmitting the BlockAckReq frame or a bandwidth signaling TA. In a BlockAckReq frame transmitted by a VHT STA or an HE STA in a non-HT or non-HT duplicate format and where the scrambling sequence carries the TXVECTOR parameter CH_BANDWIDTH_IN_NON_HT, the TA field value is a bandwidth signaling TA.

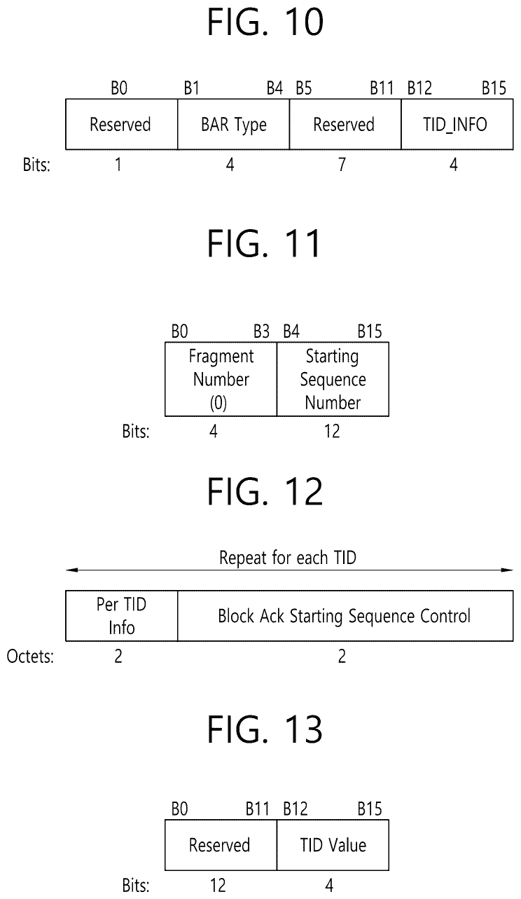

The format of the BAR control field is shown in FIG. 10.

FIG. 10 shows a format of the BAR control field.

Referring to FIG. 10, the BAR control field comprises BAR type subfield and TID_INFO subfield.

The BAR type subfield indicates the BlockAckReq frame variant. The BlockAckReq frame variant encoding is shown in table 1 below:

TABLE 1

| BAR type | BlockAckReq frame variant |
|---|---|
| 0 | Reserved |
| 1 | Extended Compressed |
| 2 | Compressed |
| 3 | Multi-TID |
| 4-5 | Reserved |
| 6 | GCR |
| 7-9 | Reserved |
| 10 | GLK-GCR |
| 11-15 | Reserved |

DMG STAs use only the Compressed BlockAckReq variant and the Extended Compressed BlockAckReq variant. The meaning of the TID_INFO subfield of the BAR Control field depends on the BlockAckReq frame variant type.

The meaning of the BAR Information field of the BlockAckReq frame depends on the BlockAckReq frame variant type.

Reference to BlockAckReq frame without any other qualification applies to any of the variants, unless specific exclusions are called out.

Examples of BlockAckReq (frame) variants are described below.

### 1. Compressed BlockAckReq (Frame) Variant

The TID_INFO subfield of the BAR Control field of the Compressed BlockAckReq frame contains the TID for which a BlockAck frame is requested.

The BAR Information field of the Compressed BlockAckReq frame contains the Block Ack Starting Sequence Control subfield, as shown in FIG. 11.

FIG. 11 shows a format of the Block Ack Starting Sequence Control subfield.

Referring to FIG. 11, the Starting Sequence Number subfield of the Block Ack Starting Sequence Control subfield contains the sequence number of the first MSDU or A-MSDU for which this BlockAckReq frame is sent. The Fragment Number subfield of the Block Ack Starting Sequence Control subfield is set to 0.

### 2. Multi-TID BlockAckReq (Frame) Variant

The TID_INFO subfield of the BAR Control field of the Multi-TID BlockAckReq frame determines the number of TIDs present in the Multi-TID BlockAckReq frame as given by TID_INFO+1, e.g., a 2 in the TID_INFO subfield means that three TID values are present in the Multi-TID BlockAckReq frame's BAR Information field.

The BAR Information field of the Multi-TID BlockAckReq frame may have a format as shown in FIG. 12.

FIG. 12 shows a format of the BAR Information field of the Multi-TID BlockAckReq frame.

Referring to FIG. 12, the BAR Information field of the Multi-TID BlockAckReq frame comprises multiple sets of Per TID Info subfields and Block Ack Starting Sequence Control subfields. The Per TID Info subfield may have a format as shown in FIG. 13.

FIG. 13 shows a format of the Per TID Info subfield.

Referring to FIG. 13, the Per TID Info subfield may contain a TID value subfield.

The Block Ack Starting Sequence Control subfield may have a format as shown in FIG. 11. The Starting Sequence Number subfield of the Block Ack Starting Sequence Control subfield contains the sequence number of the first MSDU or A-MSDU for which this BlockAckReq frame is sent. The Fragment Number subfield of the Block Ack Starting Sequence Control subfield is set to 0.

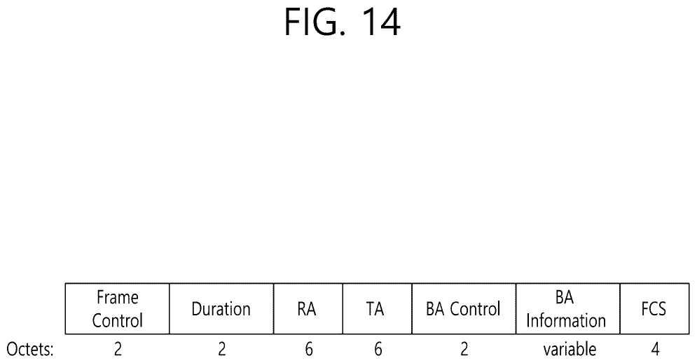

FIG. 14 shows a format of BlockAck frame.

Referring to FIG. 14, the BlockAck frame may contain frame control field, duration field, RA field, TA field, BA control field, BA information field, and/or FCS field.

The duration field value is related to the duration of the NAV timer set by the STA whose MAC address is not identical to the address of the recipient STA.

The RA field of a BlockAck frame that is not a Multi-STA BlockAck variant is set to the TA field of the soliciting frame or the address of the recipient STA from which Data frames are acknowledged.

The TA field is the address of the STA transmitting the BlockAck frame.

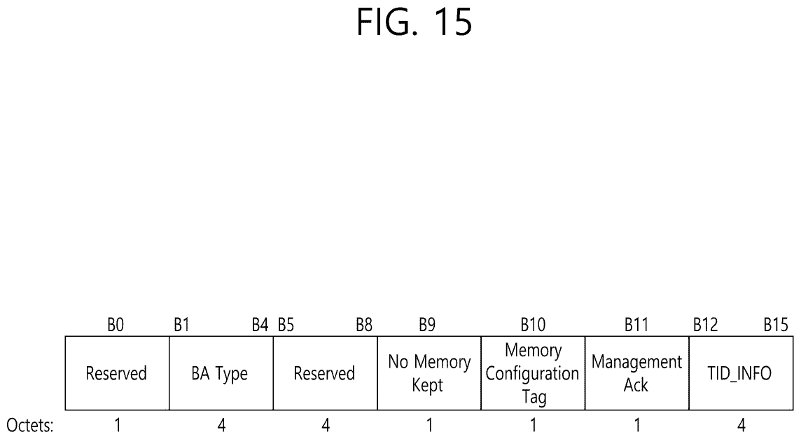

The format of the BA control field is as shown in FIG. 15.

FIG. 15 shows a format of the BA control field.

Referring to FIG. 15, the BA control field comprises BA type subfield, No Memory Kept subfield, Memory Configuration Tag subfield, Management Ack subfield, and/or TID_INFO subfield.

The BA type subfield of the BA control field indicates the BlockAck frame variant. BlockAck frame variant encoding is shown in table 2 below:

TABLE 2

| BAR type | BlockAck frame variant |
|---|---|
| 0 | Reserved |
| 1 | Extended Compressed |
| 2 | Compressed |
| 3 | Multi-TID |
| 4-5 | Reserved |
| 6 | GCR |
| 7 | EDMG Multi-TID |
| 8 | EDMG Compressed |
| 9 | Reserved |
| 10 | GLK-GCR |
| 11 | Multi-STA |
| 12-15 | Reserved |

In the present disclosure, reference to BlockAck frame without any other qualification applies to any of the variants, unless specific exclusions are called out.

The GCR BlockAck frame is used in response to a GCR BlockAckReq frame, and the GLK-GCR BlockAck frame is used in response to a GLK-GCR BlockAckReq frame.

An EDMG STA sets the No Memory Kept subfield to 1 to indicate that the free memory space indicated in the last RBUFCAP subfield might not be kept at the start of the next frame exchange sequence; otherwise, if set to 0, free memory space indicated by the RBUFCAP subfield is kept by the receiver for the next frame exchange sequence for the corresponding TID(s). The No Memory Kept subfield is reserved if transmitted by a STA that is not an EDMG STA.

For an EDMG STA, the Memory Configuration Tag subfield indicates one out of two memory configurations as indicated in Memory Configuration Tag field in the recipient's EDMG Flow Control Extension Configuration element. For other types of STAs, this subfield is reserved.

The Management Ack subfield is set to 1 to indicate that a frame of type Management and subtype that is not Action No Ack is acknowledged. This subfield is reserved if the BlockAck variant used is not the EDMG Multi-TID BlockAck variant.

The meaning of the TID_INFO subfield of the BA Control field depends on the BlockAck frame variant type. The meaning of the BA Information field depends on the BlockAck frame variant type.

Examples of BlockAck (frame) variants are described below.

### 1. Compressed BlockAck (Frame) Variant

The TID_INFO subfield of the BA Control field of the Compressed BlockAck frame contains the TID for which this BlockAck frame is sent.

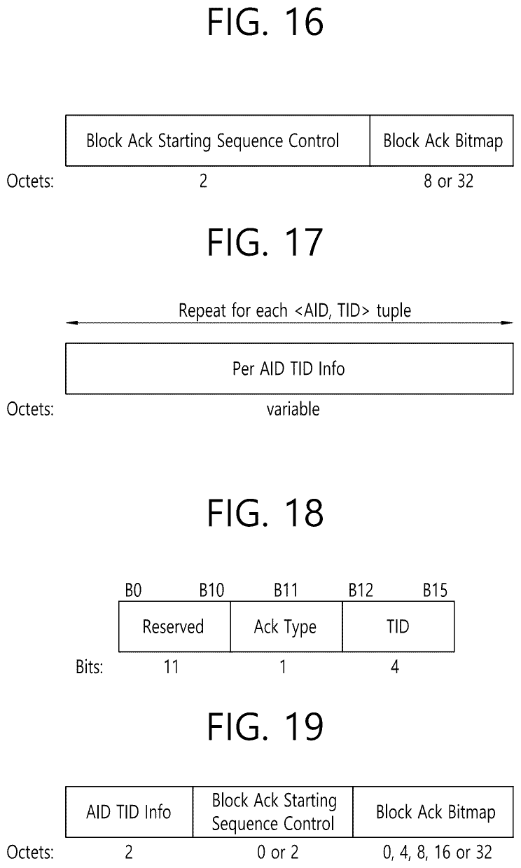

The BA Information field of the Compressed BlockAck frame may have a format as shown in FIG. 16.

FIG. 16 shows a format of the BA Information field of the Compressed BlockAck frame.

Referring to FIG. 16, the BA Information field of the Compressed BlockAck frame may contain Block Ack Starting Sequence Control subfield and/or Block Ack bitmap subfield.

The Block Ack Starting Sequence Control subfield may have a format as shown in FIG. 11. The Starting Sequence Number subfield of the Block Ack Starting Sequence Control subfield contains the sequence number of the first MSDU or A-MSDU for which this BlockAck frame is sent.

The Fragment Number subfield of the Block Ack Starting Sequence Control field is set according to Fragment Number subfield encoding for the Compressed BlockAck variant shown in table 3 below:

TABLE 3

| | | | | | Maximum |
|---|---|---|---|---|---|
| | | | | Block Ack | number of |
| | | | | bitmap | MSDUs/A- |
| Fragment Number subfield | | | Fragmentation | subfield | MSDUs that |
| | B 2 − | | level 3 | length | can be |
| B 3 | B 1 | B 0 | (ON/OFF) | (octets) | acknowledged |
| 0 | 0 | 0 | OFF | 8 | 64 |
| 0 | 1 | 0 | | Reserved | Reserved |
| 0 | 2 | 0 | | 32 | 256 |
| 0 | 3 | 0 | | Reserved | Reserved |
| 0 | 0 | 1 | ON | 8 | 16 |
| 0 | 1 | 1 | | Reserved | Reserved |
| 0 | 2 | 1 | | 32 | 64 |
| 0 | 3 | 1 | | Reserved | Reserved |
| 1 | Any | Any | | Reserved | Reserved |

A Compressed BlockAck frame with B0 of the Fragment Number subfield set to 1 is not sent to an HE STA whose Dynamic Fragmentation Support subfield in the HE Capabilities element it transmits is not set to 3. If B0 of the Fragment Number subfield is 0, the Block Ack Bitmap subfield of the BA Information field of the Compressed BlockAck frame indicates the receive status of up to 64 or 256 MSDUs and/or A-MSDUs depending upon the value of B2-B1 in the Fragment Number subfield as shown in table 3. Each bit that is equal to 1 in the compressed Block Ack Bitmap subfield acknowledges the reception of a single MSDU or A-MSDU in the order of sequence number, with the first bit of the Block Ack Bitmap subfield corresponding to the MSDU (or fragment thereof) or A-MSDU (or fragment thereof) with the sequence number that matches the Starting Sequence Number subfield of the Block Ack Starting Sequence Control subfield.

If B0 of the Fragment Number subfield is 1, the Block Ack Bitmap subfield of the BA Information field of the Compressed BlockAck frame indicates the receive status of up to 16 or 64 MSDUs and/or A-MSDUs depending upon the value B2-B1 in the Fragment Number subfield as shown in table 3. If bit position n of the Block Ack Bitmap subfield is 1, it acknowledges receipt of an MPDU with sequence number value SN and fragment number value FN with n=4×(SN−SSN)+FN, where SSN is the value of the Starting Sequence Number subfield of the Block Ack Starting Sequence Control subfield and the operations on the sequence numbers are performed modulo 4096. If bit position n of the Block Ack Bitmap subfield is 0, it indicates that the MPDU has not been received.

If the B0 of the Fragment Number subfield is equal to 1, then the Block Ack Bitmap subfield is split into (Block Ack Bitmap subfield length)/4 subbitmaps, each of which indicates receive status for 4 fragments of each of the MSDUs or A-MSDUs as indicated in table 3.

### 2. Multi-STA BlockAck (Frame) Variant

The Multi-STA BlockAck frame is supported if either UL MU or multi-TID A-MPDU operation is supported and acknowledges MPDUs carried in an HE TB PPDU or multi-STA multi-TID, multi-STA single-TID, or single-STA multi-TID A-MPDUs.

An HE AP that sends a Multi-STA BlockAck frame where the Per AID TID Info fields are addressed to more than one STA sets the RA field to the broadcast address. An HE AP that sends a Multi-STA BlockAck frame where the Per AID TID Info fields are all addressed to a single recipient STA and that is sent in response to an HE TB PPDU sets the RA field of the Multi-STA BlockAck frame to either the address of the recipient STA or to the broadcast address. An HE AP that sends a Multi-STA BlockAck frame where the Per AID TID Info fields are all addressed to a single recipient STA and that is not sent in response to an HE TB PPDU sets the RA field of the Multi-STA BlockAck frame to the address of the recipient STA.

A non-AP HE STA sets the RA field to the TA field of the soliciting frame or to the address of the recipient STA whose Data or Management frames are acknowledged.

The TID_INFO subfield of the BA Control field of the Multi-STA BlockAck frame is reserved.

The BA Information field of the Multi-STA BlockAck frame may have a format as shown in FIG. 17.

FIG. 17 shows a format of the BA Information field of the Multi-STA BlockAck frame.

Referring to FIG. 17, the BA Information field of the Multi-STA BlockAck frame may comprise one or more Per AID TID Info subfields. The Per AID TID Info subfield may contain an AID TID Info subfield, and the AID TID Info subfield may have a format as shown in FIG. 18.

FIG. 18 shows a format of the AID TID Info subfield.

Referring to FIG. 18, the AID TID Info subfield may contain AID11 subfield, Ack type subfield, and/or TID subfield.

The AID11 subfield carries the 11 LSBs of the AID of the non-AP STA for which the Per AID TID Info subfield is intended. The format of the Per AID TID Info subfield depends on the value of the AID11 subfield. If the Multi-STA BlockAck frame is sent to an AP, the AID11 subfield is set to O. A value of 2045 in the AID11 subfield is used as an identifier for any unassociated STA. If the AID11 subfield is set to 2045, then the Ack Type subfield and TI subfield are set to 0 and 15, respectively.

More than one Per AID TID Info subfield with the same value in the AID11 subfield but different values in the TID subfield can be present in the Multi-STA BlockAck frame.

If the AID11 subfield of the AID TID Info subfield is not 2045, then the Per AID TID Info subfield may have a format as shown in FIG. 19.

FIG. 19 shows a format of the Per AID TID Info subfield if the AID11 subfield is not 2045.

Referring to FIG. 19, if the AID11 subfield is not 2045, the Per AID TID Info subfield of the Multi-STA BlockAck frame may contain AID TID Info subfield, Block Ack Starting Sequence Control subfield, and/or Block Ack bitmap subfield. The context and the presence of each optional subfield in a Per AID TID Info subfield in a Multi-STA BlockAck frame is shown in table 4:

TABLE 4

| | | Presence | |
|---|---|---|---|
| | | of Block | |
| | | Ack Starting | |
| | | Sequence | |
| | | Control | |
| Ack | | subfield | Context of a Per AID |
| Type | TID | and Block | TID Info subfield |
| subfied | subfield | Ack Bitmap | in a Multi-STA |
| values | values | subfields | BlockAck frame |
| 0 | 0-7 | Present | Block acknowledgment |
| | | | context: |
| | | | Sent as an |
| | | | acknowledgment to QoS Data |
| | | | frames that solicit a BlockAck |
| | | | frame response or to a |
| | | | BlockAckReq frame |
| 1 | 0-7 | Not | Acknowledgment |
| | | present | context: |
| | | | Sent as an |
| | | | acknowledgment to a QoS Data |
| | | | or QoS Null frame that solicits |
| | | | an Ack frame response. |
| 0 or 1 | 8-13 | N/A | Reserved |
| 0 | 14 | N/A | Reserved |
| 1 | 14 | Not | All ack context: |
| | | present | Sent as an |
| | | | acknowledgment to an A- |
| | | | MPDU that contains an MPDU |
| | | | that solicits an immediate |
| | | | response and all MPDUs |
| | | | contained in the A-MPDU are |
| | | | received successfully. |
| 0 | 15 | N/A | Reserved |
| 1 | 15 | Not | Management/PS-Poll |
| | | present | frame acknowledgment |
| | | | context: |
| | | | Sent as an |
| | | | acknowledgment to a |
| | | | Management or PS-Poll frame. |

As HE STAs do not use HCCA, TID values from 8 to 15 are not used in QoS data frames. If the Ack Type subfield is 0, the Fragment Number subfield encoding indicates the length of the BlockAck bitmap subfield as shown in table 5:

TABLE 5

| | | | | | Maximum |
|---|---|---|---|---|---|
| | | | | Block | number of |
| | | | | Ack bitmap | MSDUs/A- |
| Fragment Number subfield | | | Fragmentat | subfield | MSDUs that |
| | B 2 − | | ion level 3 | length | can be |
| B 3 | B 1 | B 0 | (ON/OFF) | (octets) | acknowledged |
| 0 | 0 | 0 | OFF | 8 | 64 |
| 0 | 1 | 0 | | 16 | 128 |
| 0 | 2 | 0 | | 32 | 256 |
| 0 | 3 | 0 | | 4 | 32 |
| 0 | 0 | 1 | ON | 8 | 16 |
| 0 | 1 | 1 | | 16 | 32 |
| 0 | 2 | 1 | | 32 | 64 |
| 0 | 3 | 1 | | 4 | 8 |
| 1 | Any | Any | | Reserved | Reserved |

If B0 of the Fragment Number subfield of the Block Ack Starting Sequence Control subfield is 0, the BA Information field of the Multi-STA BlockAck frame contains an 8-octet, 16-octet, 32-octet, or 4-octet Block Ack Bitmap subfield depending on B2-B1 of the Fragment Number subfield as defined in table 5 indicating the receive status of up to 64, 128, 256, or 32 MSDUs (or fragments thereof) and/or A-MSDUs (or fragments thereof), respectively. Each bit that is equal to 1 in the Block Ack Bitmap subfield acknowledges the reception of a single MSDU (or fragment thereof) or A-MSDU (or fragment thereof) in the order of sequence number with the first bit of the Block Ack Bitmap subfield corresponding to the MSDU or A-MSDU with the sequence number that matches the value of the Starting Sequence Number subfield of the Block Ack Starting Sequence Control subfield. If B0 of the Fragment Number subfield of the Block Ack Starting Sequence Control subfield is 1, the Block Ack Bitmap subfield of the BA Information field of the Multi-STA BlockAck frame indicates the receive status of up to 16, 32, 64, or 8 MSDUs and/or A-MSDUs depending on B2−B1 of the Fragment Number subfield as shown in table 5. If bit position n of the Block Ack Bitmap subfield is 1, it acknowledges receipt of an MPDU with sequence number value SN and fragment number value FN with n=4×(SN−SSN)+FN, where SSN is the value of the Starting Sequence Number subfield of the Block Ack Starting Sequence Control subfield and the operations on the sequence numbers are performed modulo 4096. If bit position n of the Block Ack Bitmap subfield is 0, it indicates that the MPDU has not been received.

If B0 of the Fragment Number subfield is 1, then the Block Ack Bitmap subfield is split into (Block Ack Bitmap subfield length)/4 subbitmaps, each of which indicates receive status for 4 fragments of each of the MSDUs or A-MSDUs as indicated in table 5. For an A-MSDU, only the first bit of the subbitmap is used if fragmentation is not allowed in an A-MSDU.

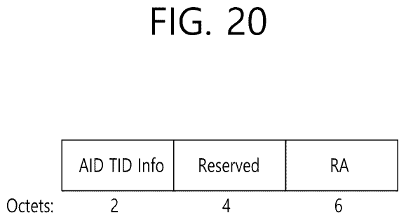

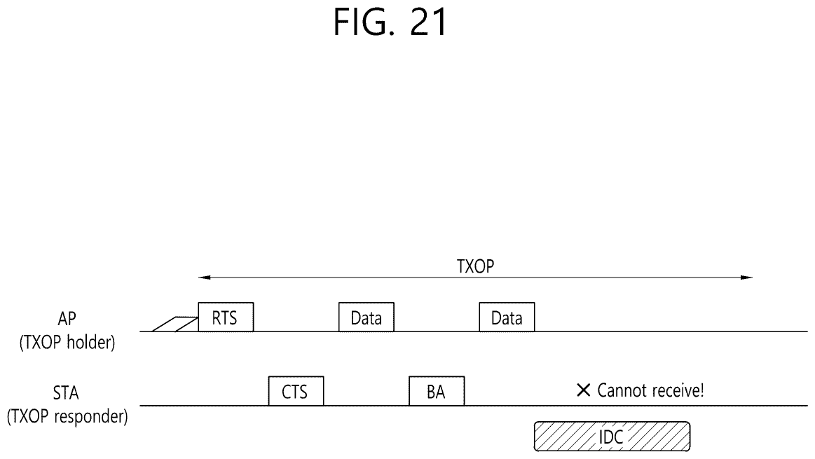

If the AID11 subfield of the AID TID Info subfield is 2045, then the Per AID TID Info subfield may have a format as shown in FIG. 20.

FIG. 20 shows a format of the Per AID TID Info subfield if the AID11 subfield is 2045.

Referring to FIG. 20, if the AID11 subfield is 2045, the Per AID TID Info subfield may contain AID TID Info subfield and/or RA subfield. The RA subfield indicates the MAC address of an unassociated STA for which the Per AID TID Info subfield is intended.

An associated non-AP HE STA that receives a Multi-STA BlockAck frame as a response from its AP and does not support the UORA procedure ignores the 10 octets following the AID TID Info subfield that are the remainder of the Per AID TID Info subfield if the AID11 subfield is 2045 and parses the following Per AID TID Info subfields if any.

Meanwhile, the current 802.11 Wi-Fi is being used together with non-Wi-Fi technologies (e.g., Bluetooth, ultra-wideband (UWB), Zigbee) in similar frequency bands (e.g., 2.4/5/6 GHZ), and Wi-Fi and non-Wi-Fi technologies can operate together at the same time to operate multiple applications. This case may be referred to as in-device coexistence (IDC), and communication with each other may be affected by the IDC. Specifically, in the present disclosure, IDC may refer to an “unavailability” state in which a non-Wi-Fi technology temporarily or periodically occupies some or all of a channel on which a Wi-Fi STA operates, thereby interfering with transmission and reception of Wi-Fi packets and/or making it impossible to transmit and receive Wi-Fi packets. IDC is a type of unavailability state, and other unavailability states may exist in addition to IDC. In this disclosure, the terms “IDC” and “unavailability” may be used interchangeably.

FIG. 21 shows an example of a situation in which an IDC occurs.

Referring to FIG. 21, if IDC occurs temporarily at a time when a STA should receive data from an AP, the STA may not be able to receive the data. If the AP does not know that an IDC will occur in the STA, data loss may occur, and since the AP may continuously retransmit data to the STA through recovery, performance degradation may occur. In this case, if information about the IDC can be transmitted in advance, data loss can be prevented.

Therefore, the present disclosure proposes a method for an STA (non-AP STA or AP) to transmit information about the IDC in advance and an apparatus implementing the method.

In the present disclosure, “field”, “subfield”, and “element” may be used interchangeably.

The specific notations (or, names) proposed in the present disclosure may be varied and are not limited thereto.

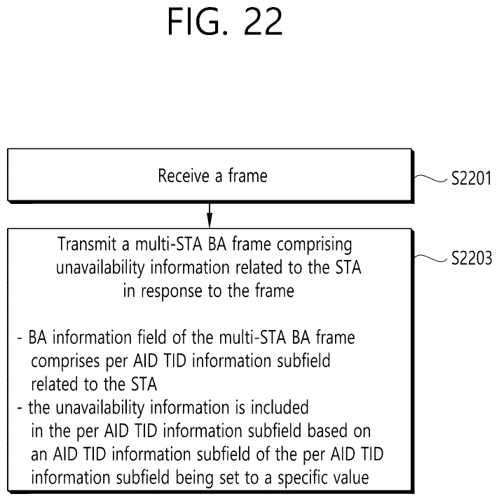

FIG. 22 shows an example of a method performed by a STA for signaling of IDC information via a multi-STA BA frame according to an embodiment of the present disclosure. Referring to FIG. 22, in step S2201, the STA may receive a frame.

In step S2203, the STA may transmit a multi-STA block acknowledgement (BA) frame comprising unavailability information related to the STA in response to the frame. BA information field of the multi-STA BA frame may comprise per association identifier (AID) traffic identifier (TID) information subfield related to the STA. The unavailability information may be included in the per AID TID information subfield based on an AID TID information subfield of the per AID TID information subfield being set to a specific value.

According to various embodiments, the unavailability information may be included instead of a BA bitmap subfield in the per AID TID information subfield.

According to various embodiments, the specific value of the AID TID information subfield may be determined based on at least one of a value of an AID 11 subfield in the AID TID information subfield, a value of an acknowledgement (Ack) type subfield in the AID TID information subfield, or a value of a TID subfield in the AID TID information subfield. For example, the value of the Ack type subfield may be 0, and the value of the TID subfield may be 13. Also, the value of the AID 11 subfield may not be 2045.

According to various embodiments, a subfield comprising the unavailability information may be located after the AID TID information subfield in the per AID TID information subfield.

According to various embodiments, the per AID TID information subfield may comprise a BA starting sequence control subfield. The BA starting sequence control subfield may be located after the AID TID information subfield in the per AID TID information subfield. The subfield comprising the unavailability information may be located after the BA starting sequence control subfield in the per AID TID information subfield.

According to various embodiments, the per AID TID information subfield may comprise a BA starting sequence control subfield. The BA starting sequence control subfield may comprise a fragment number subfield. The fragment number subfield may inform a length of a subfield including the unavailability information.

According to various embodiments, the unavailability information may comprise at least one of information for an unavailability start time or information for an unavailability duration. The unavailability start time may inform a value of timing synchronization function (TSF) at a time when the STA becomes unavailable. The unavailability duration may inform a duration in a specific time unit over which the STA is unavailable.

According to various embodiments, a subfield comprising the unavailability information may be a feedback subfield. A subfield comprising the information for the unavailability duration may be located after a subfield comprising the information for the unavailability start time in the feedback subfield.

According to various embodiments, the multi-STA BA frame may comprise information informing a presence of the unavailability information. A subfield comprising the information informing the presence of the unavailability information may be located before a subfield comprising the unavailability information in the multi-STA BA frame.

According to various embodiments, the subfield comprising the information informing the presence of the unavailability information may be a feedback type subfield. The feedback type subfield may be included in a BA starting sequence control subfield in the per AID TID information subfield.

According to various embodiments, the BA starting sequence control subfield may further comprise a fragment number subfield and a reserved subfield. The feedback type subfield may be located after the reserved subfield. The reserved subfield may be located after the fragment number subfield.

According to various embodiments, a value 0 of the feedback type subfield may inform that the unavailability information related to in-device coexistence (IDC) is present.

According to various embodiments, the information informing the presence of the unavailability information may comprise an identifier (ID) of the unavailability information.

According to various embodiments, the received frame may comprise at least one of a buffer status report poll (BSRP) trigger frame or a quality of service (QOS) data frame.

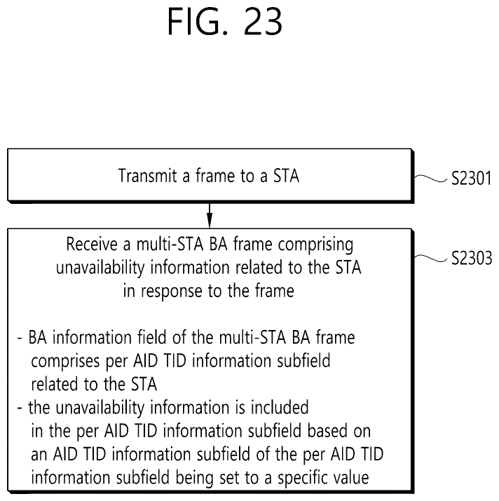

FIG. 23 shows an example of a method performed by an AP for signaling of IDC information via multi-STA BA frame according to an embodiment of the present disclosure. Referring to FIG. 23, in step S2301, the AP may transmit a frame to a STA.

In step S2303, the AP may receive a multi-STA block acknowledgement (BA) frame comprising unavailability information related to the STA in response to the frame. BA information field of the multi-STA BA frame may comprise per association identifier (AID) traffic identifier (TID) information subfield related to the STA. The unavailability information may be included in the per AID TID information subfield based on an AID TID information subfield of the per AID TID information subfield being set to a specific value.

Hereinafter, a detailed implementation of signaling of IDC information via multi-STA BA frames is described.

Information about the IDC (referred to as IDC information in the disclosure) may include at least one of the following information elements:
IDC start time (or, unavailability (target) start time): Indicates when the IDC and/or “unavailability” occurs. For example, the IDC start time/unavailability (target) start time may indicate the value of timing synchronization function (TSF) [15:7] at the time when the STA becomes unavailable. The size of the IDC start time subfield may be 9 bits/10 bits. For example, “unavailability” may mean that the STA is unavailable for the channel on which it operates, or for some subchannels (e.g., X 20 MHz subchannels) in the channel. That is, “unavailability” may not mean that the STA is always unavailable for the channel on which it operates.

For example, the entire (e.g., 8 octets) or a part (i.e., partial TSF) of the timestamp (TSF) received from the AP or the timestamp of the AP itself can be used for the IDC start time. For example, in the case of partial TSF, similar to the existing broadcast TWT, starting from a specific bit value of the TSF and up to X octets (e.g., 2 octets) of bit values can be used.

For example, the IDC start time can be indicated using the period (e.g., in units of us) from the start time of transmission or the completion time of transmission of the frame in which the current IDC start information is transmitted.

For example, the IDC start time can be indicated using the duration field of the MAC header. For example, the duration value of the duration field can be indicated to mean the period until the IDC start time. For example, if the IDC start time is indicated in the duration field, a separate indication can be omitted.
IDC duration (or, unavailability duration): The time/period during which the IDC

lasts. The size of the IDC duration subfield can be 9 bits/10 bits.

For example, the IDC duration can be indicated in a specific unit (e.g., us).

For example, information about the specific unit can be included. For example, unit information such as 1 us, 8 us, 32 us, 64 us can be included to indicate the unit for the duration value included thereafter. For example, if the duration value is 1000 and the unit is 1 us, it can mean that the IDC duration is Ims, and if the unit is 8 us, it can mean that the IDC duration is 8 ms. For example, the IDC duration/unavailability duration may indicate the duration in units of 64 us over which the STA is unavailable.

For example, the IDC duration field can have 2 octets like the duration field of the MAC header, but is not limited thereto. For example, the IDC duration field can have a size smaller than 2 octets.
IDC Interval: If the IDC occurs periodically, it can mean the interval between consecutive IDCs. For example, the IDC interval may mean the interval between the start times of consecutive IDCs.

For example, the IDC interval may be indicated in a specific unit (e.g., us).

For example, information about the specific unit may be included. For example, unit information such as 1 us, 8 us, 32 us, and 64 us may be included to indicate the unit for the interval value included thereafter. For example, if the interval value is 1000 and the unit is 1 us, it may mean that the IDC interval is Ims, and if the unit is 8 us, it may mean that the IDC interval is 8 ms.

For example, the IDC interval field may have 2 octets, like the duration field of the MAC header, but is not limited thereto. For example, the IDC interval field may have a size smaller than 2 octets.
IDC Continuity: It may mean information about how long the IDC continues.

For example, the number of IDCs each of which continues (e.g., an integer) may be indicated.

For example, the total duration from the IDC start time or the time point when the continuous IDC ends can be indicated. The duration and the time point can be indicated based on at least one of the IDC duration or the IDC start time described above, respectively.

For example, the number of beacon frames, TBTT, and/or the beacon interval can be used. For example, the number of beacon frames, TBTT, and/or the beacon interval can be used to indicate how many times the beacon will be transmitted within the interval from the time when the IDC first occurs. As another example, the number of beacon intervals from the time when the IDC first occurs can be indicated in units of beacon intervals.

For example, this IDC continuity subfield can be present when the IDC interval subfield is present.
IDC channel/bandwidth (BW): Channel/BW where IDC occurs.

For example, IDC channel/BW can be indicated using a bitmap. For example, each bit in the bitmap can indicate whether each 20 MHz subchannel is available in the operating channel/BW of the STA.

For example, since each BW of the STA can be different, BW information can be additionally indicated. For example, when BW is indicated as 20 MHz/40 MHz/80 MHz/160 MHz/320 MHz, the bitmap comprising bits of the number of 20 MHz subchannels corresponding to each BW can be configured. For example, BW information may mean a limited BW that the STA can transmit/receive due to IDC, in which case the IDC channel may not be included.
IDC NSS (number of spatial streams)/antenna: It can indicate the available (or unavailable) NSS/antenna when IDC occurs.

The IDC NSS value can mean the number of possible spatial streams. Using the IDC NSS value, the number of available (or unavailable) spatial streams due to IDC can be indicated, so that it is possible to use the actual available spatial streams.

For example, the IDC NSS/antenna subfield can indicate the index of antennas that are available or unavailable in an IDC situation. For example, it can be possible to indicate antennas with low indexes to antennas with high indexes based on MSB or LSB by using a bitmap.

The presence of information elements included in the IDC information can be determined depending on the IDC scenario. For example, if the IDC affects the primary channel of the BSS to which the STA belongs, the STA may not be able to use all channels due to the IDC, so the IDC channel may not exist. As another example, if the IDC occurs intermittently rather than periodically, the IDC interval and IDC duration subfields may not exist. Therefore, at least one of the following methods may be used:

### 1) Utilization of Presence Field

A presence field may exist for each information element. For example, if the Presence field corresponding to a specific information is 1, a field for the corresponding information may exist. For example, the Presence field may be indicated in the form of a bitmap. Additionally, if the Presence bitmap exists, the remaining bits except for the number of fields corresponding to each information element may be reserved.

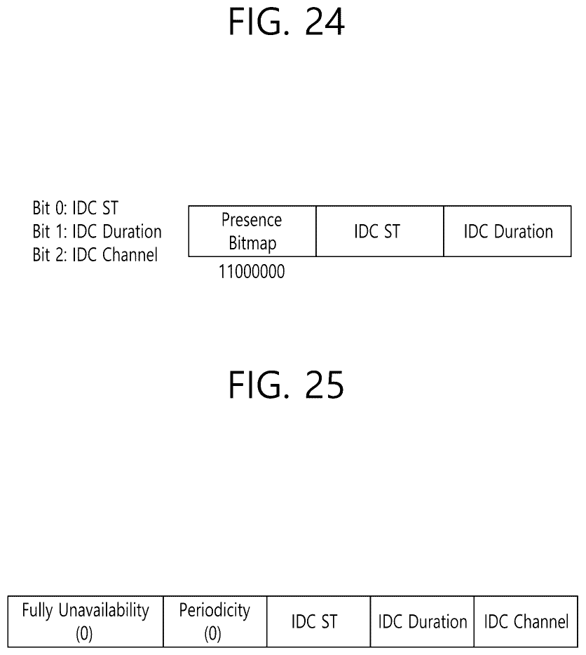

FIG. 24 shows an example of an IDC information field including a Presence bitmap according to an embodiment of the present disclosure.

Referring to FIG. 24, the Presence bitmap may indicate three information elements, and there may be an IDC start time and an IDC duration.

### 2) Fully Unavailability (e.g., 1 Bit)

For example, if the STA cannot transmit/receive on the operating channel due to the IDC, the fully unavailability may be indicated. For example, if the bit indicating the fully unavailability is set to 1 (i.e., in the case of fully unavailability), the IDC information may not include information/fields about the IDC channel.

### 3) Periodicity (e.g., 1 Bit)

If the IDC occurring in the STA occurs continuously with periodicity, the periodicity may be indicated. For example, if the bit indicating the periodicity is set to 0 (i.e., in the case of the IDC not having periodicity), the information/fields about the IDC interval and/or IDC duration may not exist in the IDC information.

FIG. 25 shows an example of an IDC information field including fields about fully unavailability and periodicity according to an embodiment of the present disclosure.

Referring to FIG. 25, the value of the fully unavailability field may be set to 0 (i.e., not fully unavailability), and the value of the periodicity field may be set to 0 (i.e., the IDC does not have periodicity). If not fully unavailability, the IDC channel field may be present in the IDC information field. In addition, since the IDC does not have periodicity, the IDC interval field and the IDC duration field may not be present in the IDC information field.

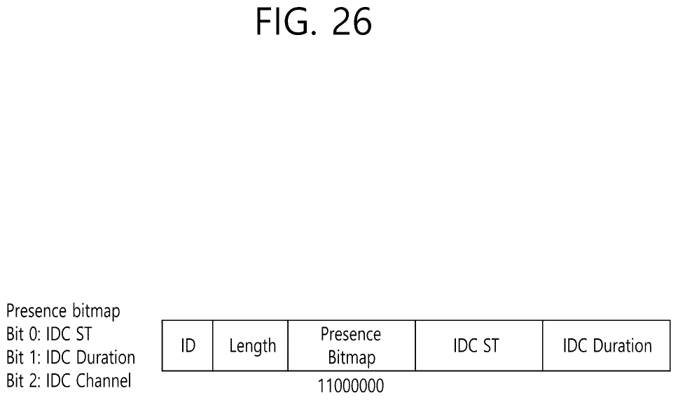

FIG. 26 shows an example of an IDC information field including a length field according to an embodiment of the present disclosure.

Referring to FIG. 26, the IDC information field may include a length field indicating the length of the IDC information field. The length field may allow a STA that cannot decode a new field added to the IDC information field to identify which field to ignore through the length field.

In addition, an ID may be assigned to the IDC information field, and the IDC information field may include such an ID. This is for flexibly transmitting control information, and only when an ID for an IDC information field is indicated, the (control) information/field including the corresponding ID can be recognized as IDC information. When another ID is indicated, the control information of the corresponding ID, not the IDC information, can be identified. In the present disclosure, a field that can include an IDC information field can be referred to as a control information field.

In some implementations, a generalized control information field can be configured. For this purpose, control information fields corresponding to one or more IDs can be included together/sequentially in a frame. For example, IDC information and other control information can be included together in a frame.

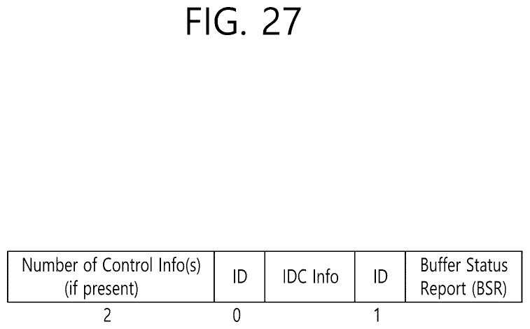

In some implementations, a generalized control information field, such as in FIG. 27, can include a field for the number of control information fields (number of control info(s)).

FIG. 27 shows an example of a generalized control information field including a field for the number of control information fields according to an embodiment of the present disclosure.

Referring to FIG. 27, the number of control information fields is 2 (i.e., the value of the number of control information fields field is 2), the ID of the IDC information may be 0, and the ID of the BSR may be 1. Therefore, two control information fields (ID=0 IDC information field, ID=1 BSR field) may be included.

In some implementations, a field for the number of control information fields may be omitted.

In some implementations, a field for the number of control information fields may be configured in a form of an element including a length field.

According to various embodiments of the present disclosure, the IDC information field (or the control information field/element including the IDC information) may be included in a multi-STA BlockAck (BA) frame. Since the multi-STA BA is a frame that can be transmitted to one or more STAs, it may include the IDC information field (or the control information field/element including the IDC information) based on at least one of the following methods (e.g., A, B).

a. Utilizing Specific Values of AID TID Info Fields of Multi-STA BA Frames

In some implementations, the presence or absence of the IDC information field may be indicated by setting the value of the AID TID Info field of the Multi-STA BA frame to a currently unused AID TID Info field value. For example, at least one of the AID11, Ack type, and/or TID fields present in the AID TID Info field of the Multi-STA BA frame may be set to a specific value to set the currently unused AID TID Info field value. For example, the Ack type may be set to 0, and the TID may be set to one of the values 8 to 15.

In some implementations, AID11 may be set to a specific value. For example, when a non-AP STA transmits a Multi-STA BA frame to the AP, AID11 may be set to a value other than 0 (e.g., 1, 2008). In such a case, the Ack type and TID may be set to any value. Since the non-AP STA transmits the Multi-STA BA frame only to the AP, the AP can identify the presence or absence of the IDC information field through the specific AID value.

In some implementations, when the AP transmits the Multi-STA BA frame to one or more non-AP STAs, AID11 can be set to a specific value (e.g., one of 0, 2008˜2044). When the AP transmits the Multi-STA BA frame to only one STA, AID11 can also be the AID of the corresponding STA.

In some implementations, when a specific value of the AID TID Info field is used, the IDC information field (or the control information field/element including the IDC information) can be included instead of the Block Ack Starting Sequence Control field and/or the Block Ack Bitmap field in the Per AID TID Info field. The size of the field can be the size of the IDC information field (or the control information field/element including the IDC information) itself.

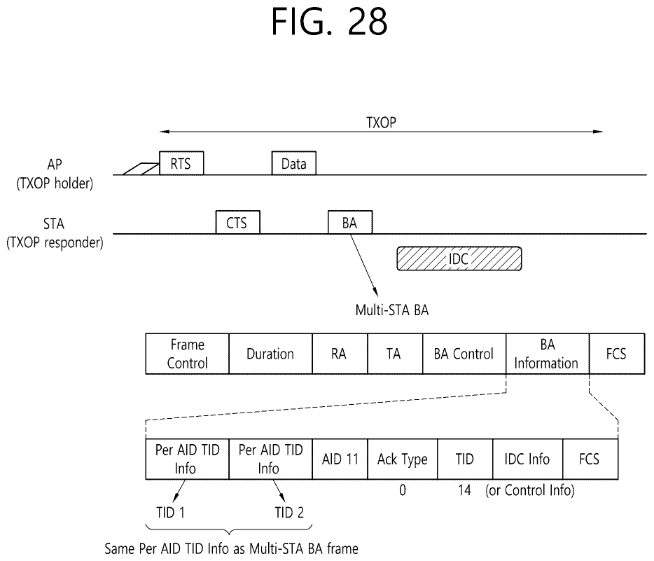

FIG. 28 shows a first example of a structure of a Multi-STA BA frame including IDC information according to an embodiment of the present disclosure.

Referring to FIG. 28, an IDC information field (or a control information field/element including IDC information) may be included in a Multi-STA BA frame by utilizing an AID TID Info field of the Multi-STA BA frame. A STA that has received data (e.g., multi-TID A-MPDU) from an AP may transmit a Multi-STA BA frame including IDC information related to information indicating that an IDC will occur. For example, at least one of AID11, an Ack type, or a TID may be set to a specific value (e.g., an Ack type may be set to 0, a TID may be set to 14), thereby indicating that an IDC information field (or a control information field/element including IDC information) is included thereafter. Meanwhile, BA information for one or more AID/TIDs (e.g., BA information for TID 1 and TID 2 for AP in FIG. 28) may also be transmitted together with the IDC information.

In some implementations, the combined size of the Block Ack Starting Sequence Control field (2 octets) and the Block Ack Bitmap size (e.g., 4 octets, 8 octets) may be used for the IDC information field (or the control information field/element including the IDC information). For example, the size of the Block Ack Bitmap may be determined using a specific AID11 value, an Ack type=0, a TID=any value and/or a fragment number subfield value, and the IDC information field (or the control information field/element including the IDC information) may be included using the Block Ack Starting Sequence Control field and/or the Block Ack Bitmap field. If the field size that can be utilized is larger than the field size of the IDC information field (or the control information field/element including the IDC information), the remaining bits except for the IDC information field (or the control information field/element including the IDC information) may be reserved. For example, when the fragment number subfield={B3=0, B2-B1=3, B0=0}, the IDC information field (or the control information field/element including the IDC information) may be included by utilizing the block Ack bitmap size of 4 octets.

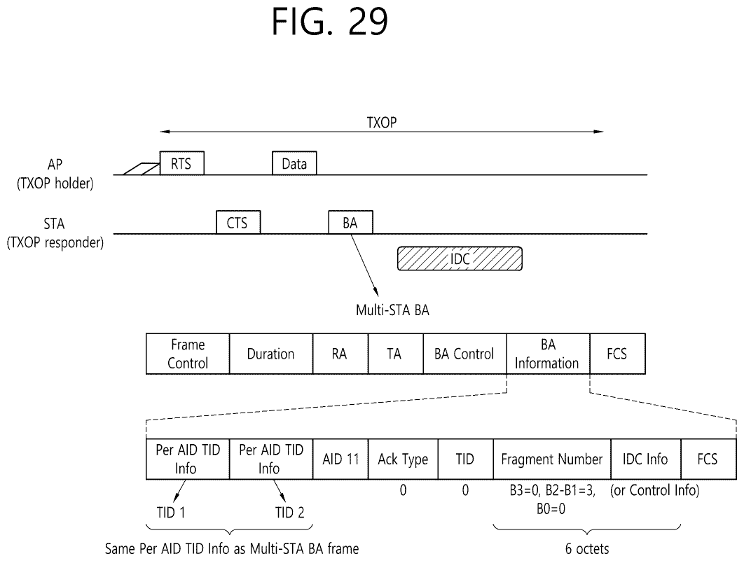

FIG. 29 shows a second example of a structure of a Multi-STA BA frame including IDC information according to an embodiment of the present disclosure.

Referring to FIG. 29, the IDC information field (or the control information field/element including the IDC information) may be included in the Multi-STA BA frame by utilizing the AID TID Info field of the Multi-STA BA frame. A STA that receives data (e.g., multi-TID A-MPDU) from an AP may transmit a multi-STA BA frame that includes IDC information related to information indicating that an IDC will occur. For example, the presence of a Block Ack Starting Sequence Control field (e.g., 2 octets) may be determined by setting at least one of the Ack Type or TID to a specific value (e.g., both the Ack Type and TID are set to 0), and the size of the Block Ack Bitmap (e.g., 4 octets) may be determined by setting the Fragment Number field to {B3=0, B2−B1=3, B0=0}. Accordingly, the Ack Type, TID, and/or Fragment Number fields may be utilized to include an IDC information field (or a control information field/element including the IDC information) instead of the existing information (e.g., a Block Ack Bitmap subfield).

In some implementations, the AID11 subfield set to a specific value may be used to indicate whether the IDC information field (or a control information field/element including the IDC information) is included. For example, by utilizing AID11, Ack type, TID, and/or fragment number fields, an IDC information field (or a control information field/element including IDC information) may be included instead of existing information (e.g., Block Ack bitmap subfield).

In some implementations, the IDC information field (or a control information field/element including IDC information) may be included, and the remaining bits other than the IDC information field (or a control information field/element including IDC information) may be reserved.

By indicating the size of the block Ack bitmap (or the IDC information field (or the control information field/element including IDC information)), a STA that cannot decode the presence of IDC information when a Multi-STA BA frame is transmitted to multiple STAs may be able to identify the length of each AID TID Info field. Meanwhile, BA information for one or more AIDs/TIDs (e.g., BA information for TID 1 and TID 2 for the AP in FIG. 29) before the IDC information may also be transmitted.

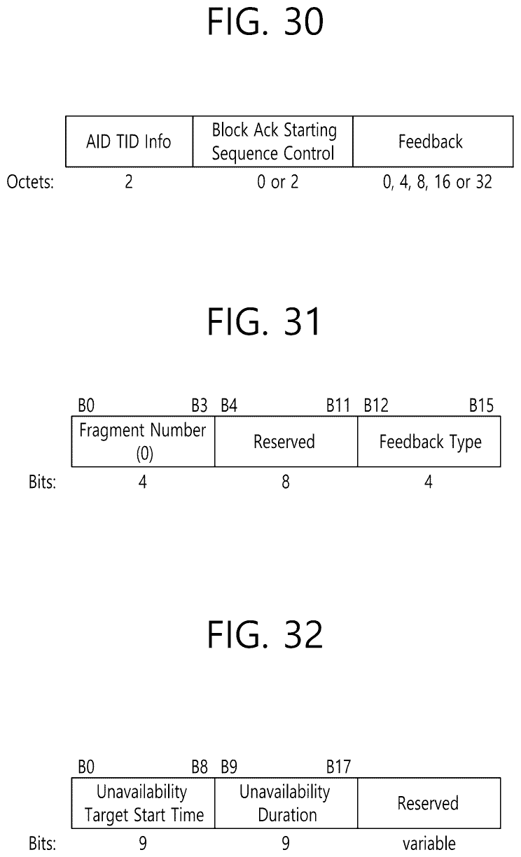

FIG. 30 shows an example of a format of a Per AID TID Info subfield including IDC/unavailability information according to an embodiment of the present disclosure.

Referring to FIG. 30, for example, if the value of the AID11 subfield in the AID TID Info subfield is a value other than 2045, the value of the Ack type subfield is 0, and/or the value of the TID subfield is 13, the Per AID TID Info subfield may include a corresponding AID TID Info subfield, a Block Ack Starting Sequence Control subfield, and a feedback subfield. That is, compared to FIG. 19, the Per AID TID Info subfield may include a feedback subfield instead of a Block Ack bitmap subfield. The feedback subfield may be a subfield including feedback information such as IDC/unavailability information (e.g., an IDC information field (or a control information field/element including IDC/unavailability information)). An example of a format of the Block Ack Starting Sequence Control subfield is described in FIG. 31. An example of the format of the feedback subfield is described in FIG. 32.

FIG. 31 shows an example of a format of the Block Ack Starting Sequence Control subfield when IDC/unavailability information is included according to an embodiment of the present disclosure.

Referring to FIG. 31, when IDC/unavailability information is included (e.g., when the value of the AID11 subfield in the AID TID Info subfield is a value other than 2045, the value of the Ack type subfield is 0, and/or the value of the TID subfield is 13), the Block Ack Starting Sequence Control subfield may include a fragment number subfield, a reserved subfield, and a feedback type subfield.

The fragment number subfield may indicate the length of the feedback subfield according to the fragment number subfield encoding in table 5.

The feedback type subfield may include information for identifying the IDC/unavailability information (e.g., an ID of the IDC/unavailability information). For example, if the value of the feedback type subfield is 0, it may indicate that IDC/unavailability information is included. In other words, the feedback type subfield whose value is set to 0 may be related to information for identifying the IDC/unavailability information (e.g., an ID of the IDC/unavailability information).

FIG. 32 shows an example of a format of a feedback subfield according to an embodiment of the present disclosure.

Referring to FIG. 32, the feedback subfield may be a subfield including feedback information such as IDC/unavailability information (e.g., an IDC information field (or, a control information field/element including the IDC/unavailability information)). For example, the feedback subfield may include an IDC start time/unavailability (target) start time subfield, an IDC duration/unavailability duration subfield, and a reserved subfield.

The IDC start time/unavailability (target) start time subfield may indicate the value of timing synchronization function (TSF) [15:7] at the time when the STA becomes unavailable. The size of the IDC start time subfield can be 9 bits/10 bits.

The IDC duration/unavailability duration subfield may indicate the duration in specific units (e.g., in units of 64 us) over which the STA is not available (or, unavailable). The size of the IDC duration/unavailability duration subfield can be 9 bits/10 bits.

### B. Utilizing a Specific Value of the Fragment Number Field of the Block Ack Starting Sequence Control Field of the Multi-STA BA Frame

In some implementations, the presence of the IDC information can be indicated by setting a specific value of the Fragment Number field of the Block Ack Starting Sequence Control field of the Per AID TID Info field.

For example, a specific value of the Fragment Number field that is not used in the Fragment Number field (e.g., indicating a reserved value for the Block Ack bitmap) can be used (e.g., B3=1, B2-B1=3, B0=1).

If a specific value of the fragment number field is used, the IDC information field (or the control information field/element containing the IDC information) may be included instead of the Block Ack bitmap subfield. For example, the size of the field may be the size of the IDC information field (or the control information field/element containing the IDC information) itself. For example, the size of the Block Ack bitmap subfield may be used as the size of the IDC information field (or the control information field/element containing the IDC information). For example, if 4 octets are used, the remaining bits except for the bits used for the IDC information field (or the control information field/element containing the IDC information) may be reserved.

In some implementations, method B may be used together with method A.

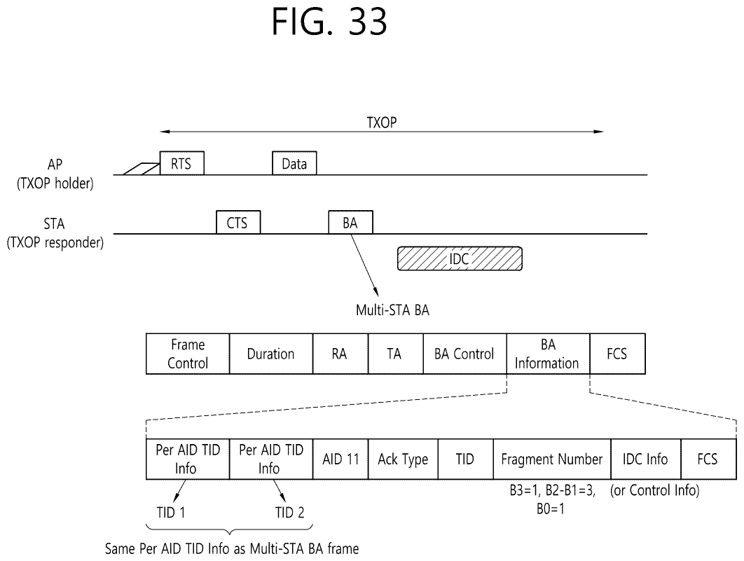

FIG. 33 shows a third example of a structure of a Multi-STA BA frame including IDC information according to an embodiment of the present disclosure.

Referring to FIG. 33, whether an IDC information field (or a control information field/element including IDC information) is included can be indicated by utilizing a specific value of a Fragment Number field in BA information of a Multi-STA BA frame. For example, the Fragment Number field can be set to 1111 (i.e., B3=1, B2−B1=3, B0=1), indicating that an IDC information field (or a control information field/element including IDC information) is included thereafter. This method can indicate whether there is IDC information when a multi-STA BA frame is transmitted to a STA. Meanwhile, BA information for one or more AIDs/TIDs (e.g., BA information for TID 1 and TID 2 for an AP in FIG. 33) before the IDC information can also be transmitted.

In some implementations, the presence of the IDC information field can be indicated using at least one bit of the bits of the reserved field, through which the receiving STA can identify in advance that the IDC information is present or absent.

In some implementations, the presence of the IDC information field (or the control information field/element including the IDC information) can be indicated using an ID as in FIG. 26 and FIG. 27. In this case, if the presence of the IDC information field (or the control information field/element including the IDC information) is indicated and the IDC information field (or the control information field/element including the IDC information) exists, the receiving STA can identify that the IDC information field (or the control information field/element including the IDC information) is included based on a specific ID mapped to the IDC information.

In some implementations, at least one of the No Memory Kept subfield, the Memory Configuration Tag subfield, or the Management Ack subfield, which is not used by non-DMG STAs, may be replaced with a presence field for the IDC information field (or the control information field/element containing the IDC information).

In some implementations, a specific value (e.g., 0, 2) of the TID_INFO subfield may be used instead of a bit in the reserved field to indicate the presence of the IDC information field (or the control information field/element containing the IDC information).

In some implementations, the IDC information field (or the control information field/element containing the IDC information) may be located next to (or after) the BA information field, if present.

In some implementations, the BA information field may not be included when the IDC information field and/or the control information field (containing the IDC information field) are included. In such a case, whether or not to additionally include the BA information field may be indicated based on at least one of the above-described methods.

In various embodiments, the Multi-STA BA frame may be a response to a data frame.

In various embodiments, the Multi-STA BA frame may be a response to a frame other than a data frame.

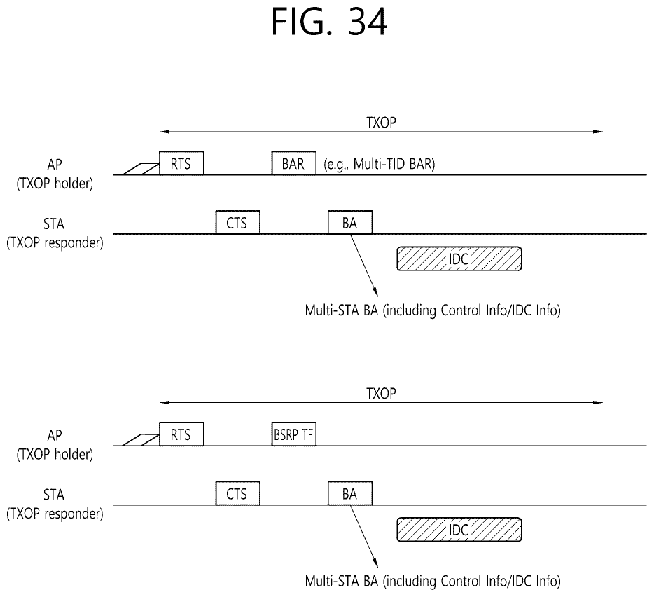

FIG. 34 shows an example of transmitting a Multi-STA BA frame including IDC information as a response to a frame according to an embodiment of the present disclosure.

Referring to FIG. 34, a Multi-STA BA frame including an IDC information field (or a control information field/element including IDC information) may be transmitted as a response to a BlockAckReq (BAR) frame (e.g., a Multi-TID BAR), a basic TF, a BSRP TF, a BQRP TF, or another frame variant.

The technical features of the present disclosure described above can be applied to various devices and methods. For example, the technical features of the present disclosure described above can be performed/supported by the devices of FIG. 1 and/or FIG. 5. For example, the technical features of the present disclosure described above can be applied only to a part of FIG. 1 and/or FIG. 5. For example, the technical features of the present disclosure described above can be implemented based on the processing chips 114, 124 of FIG. 1, or implemented based on the processors 111, 121 and the memories 112, 122 of FIG. 1, or implemented based on the processor 510 and the memory 520 of FIG. 5.

For example, the processor 121 and/or the processing chip 124 of FIG. 1 can be configured to execute instructions stored in the memory 122 to perform operations performed by the STA in the present disclosure. The operations comprise: receiving a frame; and transmitting a multi-STA block acknowledgement (BA) frame comprising unavailability information related to the STA in response to the frame, wherein BA information field of the multi-STA BA frame comprises per association identifier (AID) traffic identifier (TID) information subfield related to the STA, and wherein the unavailability information is included in the per AID TID information subfield based on an AID TID information subfield of the per AID TID information subfield being set to a specific value.

For example, the processor 111 of FIG. 1, the processing chip 114 and/or the processor 510 of FIG. 5 may be configured to execute instructions stored in the memories 112, 520 to perform operations performed by the AP in the present disclosure. The operations comprise: transmitting a frame to a station (STA); and receiving a multi-STA block acknowledgement (BA) frame comprising unavailability information related to the STA in response to the frame, wherein BA information field of the multi-STA BA frame comprises per association identifier (AID) traffic identifier (TID) information subfield related to the STA, and wherein the unavailability information is included in the per AID TID information subfield based on an AID TID information subfield of the per AID TID information subfield being set to a specific value.

The technical features of the present disclosure can be implemented based on a computer readable medium (CRM) (e.g., non-transitory CRM). For example, the CRM in the present disclosure may comprise at least one CRM having stored thereon a program code implementing instructions executed by at least one processor.

For example, the CRM may be the memory (122) of FIG. 1 and/or a separate external memory/storage medium/disk. The CRM may have stored thereon one or more program codes implementing instructions that, based on being executed by the processor (e.g., the processor 121 and/or the processing chip 124 of FIG. 1), perform operations performed by the STA in the present disclosure. The operations comprise: receiving a frame; and transmitting a multi-STA block acknowledgement (BA) frame comprising unavailability information related to the STA in response to the frame, wherein BA information field of the multi-STA BA frame comprises per association identifier (AID) traffic identifier (TID) information subfield related to the STA, and wherein the unavailability information is included in the per AID TID information subfield based on an AID TID information subfield of the per AID TID information subfield being set to a specific value.

For example, the CRM may be the memory 112 of FIG. 1, the memory 520 of FIG. 5, and/or a separate external memory/storage medium/disk. The above CRM may have stored thereon one or more program codes implementing instructions that, based on being executed by a processor (e.g., the processor 111 of FIG. 1, the processing chip 114 and/or the processor 510 of FIG. 5), perform operations performed by the AP in the present disclosure. The operations comprise: transmitting a frame to a station (STA); and receiving a multi-STA block acknowledgement (BA) frame comprising unavailability information related to the STA in response to the frame, wherein BA information field of the multi-STA BA frame comprises per association identifier (AID) traffic identifier (TID) information subfield related to the STA, and wherein the unavailability information is included in the per AID TID information subfield based on an AID TID information subfield of the per AID TID information subfield being set to a specific value.

The foregoing technical features of this disclosure are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The present disclosure may have various advantageous effects.

For example, an AP/STA that has received IDC information from a counterpart STA may not transmit frames to the counterpart STA during IDC duration so that Wi-Fi performance degradation can be prevented.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus, and technical features in method claim(s) and apparatus claim(s) can be combined to be implemented or performed in a method.

What is claimed is:

1. A method comprising:
receiving, by a station (STA), a frame; and
transmitting, by the STA, a multi-STA block acknowledgement (BA) frame comprising unavailability information related to the STA in response to the frame,
wherein BA information field of the multi-STA BA frame comprises per association identifier (AID) traffic identifier (TID) information subfield related to the STA, and
wherein the unavailability information is included in the per AID TID information subfield based on an AID TID information subfield of the per AID TID information subfield being set to a specific value.

2. The method of claim 1, wherein the unavailability information is included instead of a BA bitmap subfield in the per AID TID information subfield.

3. The method of claim 1, wherein the specific value of the AID TID information subfield is determined based on at least one of a value of an AID 11 subfield in the AID TID information subfield, a value of an acknowledgement (Ack) type subfield in the AID TID information subfield, or a value of a TID subfield in the AID TID information subfield.

4. The method of claim 3, wherein the value of the Ack type subfield is 0, and wherein the value of the TID subfield is 13.

5. The method of claim 4, wherein the value of the AID 11 subfield is not 2045.

6. The method of claim 1, wherein a subfield comprising the unavailability information is located after the AID TID information subfield in the per AID TID information subfield.

7. The method of claim 6, wherein the per AID TID information subfield comprises a BA starting sequence control subfield,
wherein the BA starting sequence control subfield is located after the AID TID information subfield in the per AID TID information subfield, and
wherein the subfield comprising the unavailability information is located after the BA starting sequence control subfield in the per AID TID information subfield.

8. The method of claim 1, wherein the per AID TID information subfield comprises a BA starting sequence control subfield,
wherein the BA starting sequence control subfield comprises a fragment number subfield, and
wherein the fragment number subfield informs a length of a subfield including the unavailability information.

9. The method of claim 1, wherein the unavailability information comprises at least one of information for an unavailability start time or information for an unavailability duration,
wherein the unavailability start time informs a value of timing synchronization function (TSF) at a time when the STA becomes unavailable, and
wherein the unavailability duration informs a duration in a specific time unit over which the STA is unavailable.

10. The method of claim 9, wherein a subfield comprising the unavailability information is a feedback subfield, and
wherein a subfield comprising the information for the unavailability duration is located after a subfield comprising the information for the unavailability start time in the feedback subfield.

11. The method of claim 1, wherein the multi-STA BA frame comprises information informing a presence of the unavailability information, and
wherein a subfield comprising the information informing the presence of the unavailability information is located before a subfield comprising the unavailability information in the multi-STA BA frame.

12. The method of claim 11, wherein the subfield comprising the information informing the presence of the unavailability information is a feedback type subfield, and
wherein the feedback type subfield is included in a BA starting sequence control subfield in the per AID TID information subfield.

13. The method of claim 12, wherein the BA starting sequence control subfield further comprises a fragment number subfield and a reserved subfield,
wherein the feedback type subfield is located after the reserved subfield, and
wherein the reserved subfield is located after the fragment number subfield.

14. The method of claim 12, wherein a value 0 of the feedback type subfield informs that the unavailability information related to in-device coexistence (IDC) is present.

15. The method of claim 11, wherein the information informing the presence of the unavailability information comprises an identifier (ID) of the unavailability information.

16. The method of claim 1, wherein the received frame comprises at least one of a buffer status report poll (BSRP) trigger frame or a quality of service (QOS) data frame.

17. A station (STA) comprising:
a transceiver;
a memory; and
at least one processor operably coupled to the transceiver and the memory,
wherein the memory stores instructions that, based on being executed by the at least one processor, perform operations comprising:
receiving a frame; and
transmitting a multi-STA block acknowledgement (BA) frame comprising unavailability information related to the STA in response to the frame,
wherein BA information field of the multi-STA BA frame comprises per association identifier (AID) traffic identifier (TID) information subfield related to the STA, and
wherein the unavailability information is included in the per AID TID information subfield based on an AID TID information subfield of the per AID TID information subfield being set to a specific value.

18. An access point (AP) comprising:
a transceiver;
a memory; and
at least one processor operably coupled to the transceiver and the memory,
wherein the memory stores instructions that, based on being executed by the at least one processor, perform operations comprising:
transmitting a frame to a station (STA); and
receiving a multi-STA block acknowledgement (BA) frame comprising unavailability information related to the STA in response to the frame,
wherein BA information field of the multi-STA BA frame comprises per association identifier (AID) traffic identifier (TID) information subfield related to the STA, and
wherein the unavailability information is included in the per AID TID information subfield based on an AID TID information subfield of the per AID TID information subfield being set to a specific value.
